(19) United States
(12) Patent Application Publication
(10) Pub. No.: US 2026/0271103 A1
(43) Pub. Date: Sep. 10, 2026

(54) PHYSICAL CELL IDENTIFIER INDICATION USING SYNCHRONIZATION SIGNALS

(71) Applicant: QUALCOMM Incorporated, San Diego, CA (US)

(72) Inventors: Hung Dinh LY, San Diego, CA (US); Jing JIANG, San Diego, CA (US); Yan ZHOU, San Diego, CA (US)

(21) Appl. No.: 19/070,862

(22) Filed: Mar. 5, 2025

(51) Int. Cl. H04W 76/11; H04L 5/00

(52) U.S. Cl. CPC H04W 76/11; H04L 5/0048

(57) ABSTRACT

Methods, systems, and devices for wireless communications are described. A user equipment (UE) may receive a synchronization signal block (SSB) including first signal, such as a primary synchronization signal (PSS) or a discovery reference signal, and a second signal, such as a secondary synchronization signal (SSS) or a single signal. In some examples, the second signal indicates a physical cell identifier (PCID) of a network entity without additional information from the first signal. In some examples, the SSB may include a first signal, a second signal, and a physical broadcast channel (PBCH). In some examples, the second signal may indicate first information associated with a PCID of a network entity, and the PBCH may indicate second information associated with the PCID of the network entity. The UE may establish a connection with the network entity on the PCID of the network entity.

### FIELD OF TECHNOLOGY

The following relates to wireless communications, including physical cell identifier (PCID) indication using synchronization signals.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving a synchronization signal block including a first signal, a second signal, and a physical broadcast channel (PBCH), the second signal indicating first information associated with a physical cell identifier (PCID) of a network entity, and the PBCH indicating second information associated with the PCID of the network entity and establishing a connection with the network entity based on a determination of the PCID of the network entity in accordance with the first information and the second information.

A UE for wireless communications is described. The UE may include one or more memories storing processor executable code, and one or more processors coupled with the one or more memories. The one or more processors may individually or collectively be operable to execute the code to cause the UE to receive a synchronization signal block including a first signal, a second signal, and a PBCH, the second signal indicating first information associated with a PCID of a network entity, and the PBCH indicating second information associated with the PCID of the network entity and establish a connection with the network entity based on a determination of the PCID of the network entity in accordance with the first information and the second information.

Another UE for wireless communications is described. The UE may include means for receiving a synchronization signal block including a first signal, a second signal, and a PBCH, the second signal indicating first information associated with a PCID of a network entity, and the PBCH indicating second information associated with the PCID of the network entity and means for establishing a connection with the network entity based on a determination of the PCID of the network entity in accordance with the first information and the second information.

A non-transitory computer-readable medium storing code for wireless communications is described. The code may include instructions executable by one or more processors to receive a synchronization signal block including a first signal, a second signal, and a PBCH, the second signal indicating first information associated with a PCID of a network entity, and the PBCH indicating second information associated with the PCID of the network entity and establish a connection with the network entity based on a determination of the PCID of the network entity in accordance with the first information and the second information.

In some examples of the method, UEs, and non-transitory computer-readable medium described herein, receiving the synchronization signal block may include operations, features, means, or instructions for receiving one or more demodulation reference signals of the PBCH indicating the second information associated with the PCID.

Some examples of the method, UEs, and non-transitory computer-readable medium described herein may further include operations, features, means, or instructions for descrambling the one or more demodulation reference signals of the PBCH based on the first information associated with the PCID, the determination of the PCID being based on descrambling the one or more demodulation reference signals.

In some examples of the method, UEs, and non-transitory computer-readable medium described herein, receiving the synchronization signal block may include operations, features, means, or instructions for receiving a master information block via the PBCH, the master information block indicating the second information associated with the PCID.

In some examples of the method, UEs, and non-transitory computer-readable medium described herein, the PCID of the network entity includes an area identifier and a cell identifier.

In some examples of the method, UEs, and non-transitory computer-readable medium described herein, the first information indicated by the second signal includes the area identifier and the second information indicated by the PBCH includes the cell identifier.

Some examples of the method, UEs, and non-transitory computer-readable medium described herein may further include operations, features, means, or instructions for receiving control information indicating a transmission configuration indicator state, the control information including the PCID associated with the network entity and a source reference signal associated with the transmission configuration indicator state.

A method for wireless communications by a network entity is described. The method may include outputting a synchronization signal block including a first signal, a second signal, and a PBCH, the second signal indicating first information associated with a PCID of the network entity, and the PBCH indicating second information associated with the PCID of the network entity and establishing a connection with a UE based on outputting the synchronization signal block.

A network entity for wireless communications is described. The network entity may include one or more memories storing processor executable code, and one or more processors coupled with the one or more memories. The one or more processors may individually or collectively be operable to execute the code to cause the network entity to output a synchronization signal block including a first signal, a second signal, and a PBCH, the second signal indicating first information associated with a PCID of the network entity, and the PBCH indicating second information associated with the PCID of the network entity and establish a connection with a UE based on outputting the synchronization signal block.

Another network entity for wireless communications is described. The network entity may include means for outputting a synchronization signal block including a first signal, a second signal, and a PBCH, the second signal indicating first information associated with a PCID of the network entity, and the PBCH indicating second information associated with the PCID of the network entity and means for establishing a connection with a UE based on outputting the synchronization signal block.

A non-transitory computer-readable medium storing code for wireless communications is described. The code may include instructions executable by one or more processors to output a synchronization signal block including a first signal, a second signal, and a PBCH, the second signal indicating first information associated with a PCID of the network entity, and the PBCH indicating second information associated with the PCID of the network entity and establish a connection with a UE based on outputting the synchronization signal block.

In some examples of the method, network entities, and non-transitory computer-readable medium described herein, outputting the synchronization signal block may include operations, features, means, or instructions for outputting one or more demodulation reference signals of the PBCH indicating the second information associated with the PCID.

Some examples of the method, network entities, and non-transitory computer-readable medium described herein may further include operations, features, means, or instructions for scrambling the one or more demodulation reference signals of the PBCH based on the first information associated with the PCID.

In some examples of the method, network entities, and non-transitory computer-readable medium described herein, outputting the synchronization signal block may include operations, features, means, or instructions for outputting a master information block via the PBCH, the master information block indicating the second information associated with the PCID.

In some examples of the method, network entities, and non-transitory computer-readable medium described herein, the PCID of the network entity includes an area identifier and a cell identifier.

In some examples of the method, network entities, and non-transitory computer-readable medium described herein, the first information indicated by the second signal includes the area identifier and the second information indicated by the PBCH includes the cell identifier.

Some examples of the method, network entities, and non-transitory computer-readable medium described herein may further include operations, features, means, or instructions for outputting control information indicating a transmission configuration indicator state, the control information including the PCID associated with the network entity and a source reference signal associated with the transmission configuration indicator state.

A method for wireless communications by a UE is described. The method may include receiving a synchronization signal block including a first signal and a second signal, the second signal indicating a PCID of a network entity without additional information from the first signal and establishing a connection with the network entity based on the PCID of the network entity.

A UE for wireless communications is described. The UE may include one or more memories storing processor executable code, and one or more processors coupled with the one or more memories. The one or more processors may individually or collectively be operable to execute the code to cause the UE to receive a synchronization signal block including a first signal and a second signal, the second signal indicating a PCID of a network entity without additional information from the first signal and establish a connection with the network entity based on the PCID of the network entity.

Another UE for wireless communications is described. The UE may include means for receiving a synchronization signal block including a first signal and a second signal, the second signal indicating a PCID of a network entity without additional information from the first signal and means for establishing a connection with the network entity based on the PCID of the network entity.

A non-transitory computer-readable medium storing code for wireless communications is described. The code may include instructions executable by one or more processors to receive a synchronization signal block including a first signal and a second signal, the second signal indicating a PCID of a network entity without additional information from the first signal and establish a connection with the network entity based on the PCID of the network entity.

In some examples of the method, UEs, and non-transitory computer-readable medium described herein, the second signal includes a first sequence that may be mapped to a first set of resource elements and a second sequence that may be mapped to a second set of resource elements, the first sequence and the second sequence indicating the PCID of the network entity.

In some examples of the method, UEs, and non-transitory computer-readable medium described herein, the first set of resource elements includes a first quantity of resource elements, and the second set of resource elements includes a second quantity of resource elements that may be different from the first quantity of resource elements.

In some examples of the method, UEs, and non-transitory computer-readable medium described herein, the first set of resource elements corresponds to a first symbol index of the synchronization signal block, and the second set of resource elements corresponds to a second symbol index of the synchronization signal block that may be different from the first symbol index.

In some examples of the method, UEs, and non-transitory computer-readable medium described herein, the first set of resource elements and the second set of resource elements correspond to a same symbol index of the synchronization signal block.

In some examples of the method, UEs, and non-transitory computer-readable medium described herein, a first cyclic shift applied to the first sequence and a second cyclic shift applied to the second sequence indicate the PCID of the network entity.

In some examples of the method, UEs, and non-transitory computer-readable medium described herein, receiving the synchronization signal block may include operations, features, means, or instructions for receiving a set of multiple demodulation reference signals of a PBCH including the second signal, a mapping of the set of multiple demodulation reference signals to resource elements of the synchronization signal block indicating the PCID of the network entity.

In some examples of the method, UEs, and non-transitory computer-readable medium described herein, a first symbol index of the synchronization signal block may be associated with a first demodulation reference signal density, and a second symbol index of the synchronization signal block may be associated with a second demodulation reference signal density.

A method for wireless communications by a network entity is described. The method may include outputting a synchronization signal block including a first signal and a second signal, the second signal indicating a PCID of the network entity without additional information from the first signal and establishing a connection with a UE based on the PCID of the network entity.

A network entity for wireless communications is described. The network entity may include one or more memories storing processor executable code, and one or more processors coupled with the one or more memories. The one or more processors may individually or collectively be operable to execute the code to cause the network entity to output a synchronization signal block including a first signal and a second signal, the second signal indicating a PCID of the network entity without additional information from the first signal and establish a connection with a UE based on the PCID of the network entity.

Another network entity for wireless communications is described. The network entity may include means for outputting a synchronization signal block including a first signal and a second signal, the second signal indicating a PCID of the network entity without additional information from the first signal and means for establishing a connection with a UE based on the PCID of the network entity.

A non-transitory computer-readable medium storing code for wireless communications is described. The code may include instructions executable by one or more processors to output a synchronization signal block including a first signal and a second signal, the second signal indicating a PCID of the network entity without additional information from the first signal and establish a connection with a UE based on the PCID of the network entity.

In some examples of the method, network entities, and non-transitory computer-readable medium described herein, the second signal includes a first sequence that may be mapped to a first set of resource elements and a second sequence that may be mapped to a second set of resource elements, the first sequence and the second sequence indicating the PCID of the network entity.

In some examples of the method, network entities, and non-transitory computer-readable medium described herein, the first set of resource elements includes a first quantity of resource elements, and the second set of resource elements includes a second quantity of resource elements that may be different from the first quantity of resource elements.

In some examples of the method, network entities, and non-transitory computer-readable medium described herein, the first set of resource elements corresponds to a first symbol index of the synchronization signal block, and the second set of resource elements corresponds to a second symbol index of the synchronization signal block that may be different from the first symbol index.

In some examples of the method, network entities, and non-transitory computer-readable medium described herein, the first set of resource elements and the second set of resource elements correspond to a same symbol index of the synchronization signal block.

In some examples of the method, network entities, and non-transitory computer-readable medium described herein, a first cyclic shift applied to the first sequence and a second cyclic shift applied to the second sequence indicate the PCID of the network entity.

In some examples of the method, network entities, and non-transitory computer-readable medium described herein, outputting the synchronization signal block may include operations, features, means, or instructions for outputting a set of multiple demodulation reference signals of a PBCH including the second signal, a mapping of the set of multiple demodulation reference signals to resource elements of the synchronization signal block indicating the PCID of the network entity.

In some examples of the method, network entities, and non-transitory computer-readable medium described herein, a first symbol index of the synchronization signal block may be associated with a first demodulation reference signal density, and a second symbol index of the synchronization signal block may be associated with a second demodulation reference signal density.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports physical cell identifier (PCID) indication using synchronization signals in accordance with one or more aspects of the present disclosure.

FIG. 2 shows an example of a wireless communications system that supports PCID indication using synchronization signals in accordance with one or more aspects of the present disclosure.

FIG. 3 shows an example of synchronization signal block (SSB) configurations that support PCID indication using synchronization signals in accordance with one or more aspects of the present disclosure.

FIG. 4 shows an example of a demodulation reference signal (DMRS) mapping configuration that supports PCID indication using synchronization signals in accordance with one or more aspects of the present disclosure.

FIG. 5 shows an example of an SSB periodicity configuration that supports PCID indication using synchronization signals in accordance with one or more aspects of the present disclosure.

FIG. 6 shows an example of a process flow that supports PCID indication using synchronization signals in accordance with one or more aspects of the present disclosure.

FIGS. 7 and 8 show block diagrams of devices that support PCID indication using synchronization signals in accordance with one or more aspects of the present disclosure.

FIG. 9 shows a block diagram of a communications manager that supports PCID indication using synchronization signals in accordance with one or more aspects of the present disclosure.

FIG. 10 shows a diagram of a system including a device that supports PCID indication using synchronization signals in accordance with one or more aspects of the present disclosure.

FIGS. 11 and 12 show block diagrams of devices that support PCID indication using synchronization signals in accordance with one or more aspects of the present disclosure.

FIG. 13 shows a block diagram of a communications manager that supports PCID indication using synchronization signals in accordance with one or more aspects of the present disclosure.

FIG. 14 shows a diagram of a system including a device that supports PCID indication using synchronization signals in accordance with one or more aspects of the present disclosure.

FIGS. 15 through 18 show flowcharts illustrating methods that support PCID indication using synchronization signals in accordance with one or more aspects of the present disclosure.

### DETAILED DESCRIPTION

A network entity may periodically transmit synchronization signal blocks (SSBs) that each include a first signal, such as a primary synchronization signal (PSS), a second signal, such as a secondary synchronization signal (SSS), and a physical broadcast channel (PBCH). In some examples, a user equipment (UE) may receive an SSB to perform time and frequency synchronization. In some examples, an SSB may indicate information for the UE to establish a connection with the network entity, such as for an initial access procedure or for a cell reselection procedure. For example, an SSB may indicate a physical cell identifier (PCID) of the network entity. In some implementations, a combination of a PSS and an SSS may indicate a PCID of a network entity. For example, a PSS in some implementations may include three sequences, and the three sequences of the PSS with the SSS (e.g., different configurations for the SSS) may be used to indicate a PCID of a network entity. Using fewer PSS sequences, such as using a single PSS sequence, may reduce PSS detection complexity at a UE. However, implementations that use sequences for a PSS may not support an indication of a PCID without multiple PSS sequences.

A wireless communications system described herein may be configured to support techniques for a network entity to transmit an SSB that indicates a PCID of the network entity based on a second signal of the SSB, such as an SSS or a single signal. In some examples, the second signal of an SSB may indicate the PCID of the network entity without additional information from a first signal (e.g., a PSS or a discovery reference signal (DRS) block) of the SSB. In some examples, an SSB may include two second signal sequences of different lengths. For example, first cyclic shift information of a first SSS sequence and second cyclic shift information of a second SSS sequence (e.g., amounts by which the first and second SSS sequences are cyclically shifted) may indicate the PCID. In some examples, a second signal of an SSB may indicate first information associated with a PCID of a network entity, and a PBCH of the SSB may indicate second information associated with the PCID of the network entity. For example, an SSS may indicate an area identifier, and a PBCH may indicate information associated with a specific cell within an area corresponding to the area identifier. In some examples, a PBCH demodulation reference signal (DMRS) sequence may indicate the second information associated with a PCID of a network entity. In examples, a master information block (MIB) transmitted via a PBCH (e.g., a payload of the PBCH) may indicate the second information associated with a PCID of a network entity. In some examples, DMRSs of a PBCH of an SSB may indicate a PCID of a network entity. For example, a mapping of DMRSs to a PBCH, a density of DMRSs in a PBCH, or both, may indicate a PCID of a network entity. In some examples, an SSS may be transmitted as DMRSs in a PBCH. For example, an SSB may include resource blocks (RBs) for a PSS and RBs for a PBCH, and DMRSs of the PBCH may include an SSS sequence.

Aspects of the disclosure are initially described in the context of wireless communications systems. Aspects of the disclosure are further illustrated by and described with reference to SSB configurations, a DMRS mapping configuration, an SSB periodicity configuration, a process flow, apparatus diagrams, system diagrams, and flowcharts that relate to PCID indication using synchronization signals.

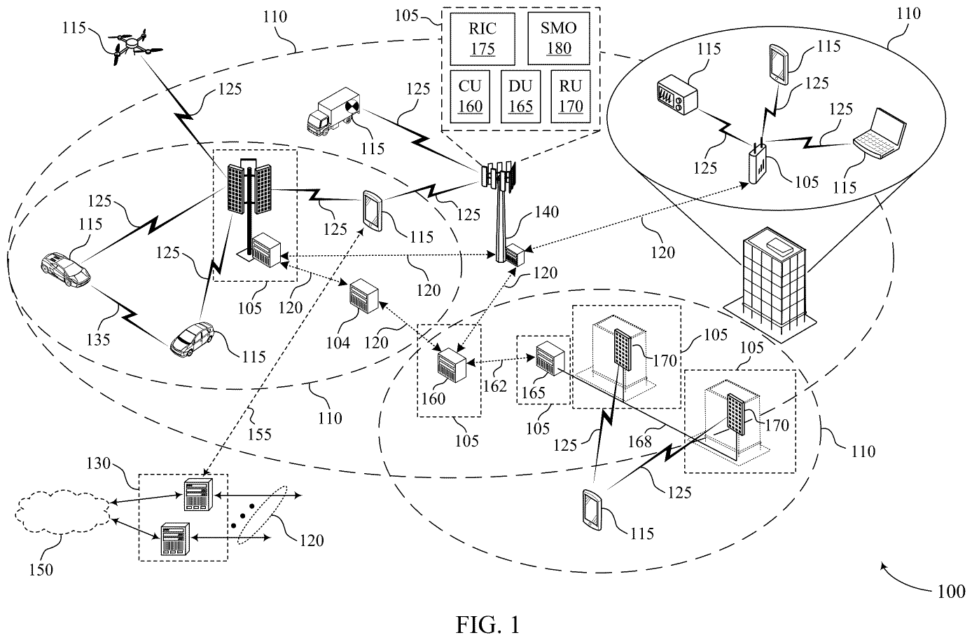

FIG. 1 shows an example of a wireless communications system 100 that supports PCID indication using synchronization signals in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support PCID indication using synchronization signals as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., Nf) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a PCID, a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In the wireless communications system 100, a network entity 105 may periodically transmit SSBs, which may be received by UEs 115 in a coverage area 110 of the network entity 105. An SSB may include a PSS, an SSS, and a PBCH. In some cases, an SSB may span four symbol periods in the time domain. In some cases, a PSS may span twelve RBs in the frequency domain, and a PBCH may span twenty RBs in the frequency domain. In some cases, an SSS may span twelve RBs in the frequency domain. In some cases, the network entity 105 may transmit a PSS, an SSS, and a PBCH using a single antenna port.

In some examples, a network entity 105 may transmit a PSS block having a first periodicity and an SSS/PBCH block having a second periodicity. In some examples, the first periodicity and the second periodicity may be the same. For example, the network entity 105 may transmit a PSS block and an SSS/PBCH block every 20 milliseconds. In some other examples, the first periodicity and the second periodicity may be different. For example, the network entity 105 may transmit one or more SSS and one or more PBCH every 20 milliseconds, and the network entity 105 may transmit one or more PSS every 80 milliseconds.

In some examples, an SSB may include a first signal, a second signal, and a PBCH. For example, the first signal may be an example of a PSS as described herein. Additionally, or alternatively, the first signal may be an example of a DRS. A UE may detect (e.g., receive) a DRS to detect or synchronize with the network entity 105. In some examples, a DRS may have similar functionality to a PSS. The second signal may be an example of an SSS as described herein. Additionally, or alternatively, the second signal may be a single signal, such as a PSS or an SSS as described herein, or a signal which includes aspects of both a PSS and an SSS. For example, an SSB may include a single synchronization signal (e.g., the single signal) and a PBCH.

In some examples, a network entity 105 may transmit a DRS block and an SSB or SS/PBCH block. For example, the network entity 105 may transmit a DRS block (e.g., including a DRS) with a first periodicity, and the network entity 105 may transmit an SSB (e.g., an SS/PBCH block including a PSS, and SSS, and a PBCH) with a second periodicity. The second periodicity and the first periodicity may be the same or different. For example, the network entity 105 may transmit a DRS block with a periodicity of 80 milliseconds, and the network entity 105 may transmit an SSB with a periodicity of 20 milliseconds.

In some examples, a UE 115 may receive an SSB to perform time and frequency synchronization. In some examples, the SSB may indicate information for the UE 115 to establish a connection with a network entity 105, such as for an initial access procedure or for a cell reselection procedure. For example, an SSB may indicate a PCID of a network entity 105. In some wireless communications systems, a combination of a PSS and an SSS may indicate the PCID of a network entity 105.

A PSS in some wireless communications systems may include three sequences, and the three sequences of the PSS with the SSS (e.g., different configurations for the SSS) may be used to indicate the PCID of a network entity 105. Using fewer PSS sequences, such as using a single PSS sequence, may reduce PSS detection complexity at a UE 115. Some wireless communications systems may support longer PSS periodicities for initial access (e.g., longer than 20 milliseconds), and complex PSS detection at a UE 115 with a longer PSS periodicity may increase a likelihood of detection failure, which may result in initial access failure and delays. However, wireless communications systems which use sequences for a PSS may not support an indication of a PCID without multiple PSS sequences.

The wireless communications system 100 may be configured to support techniques for a network entity 105 to transmit an SSB that indicates a PCID of the network entity 105. For example, an SSS of an SSB may indicate the PCID of a network entity 105. In some examples, an SSS of an SSB may indicate the PCID of a network entity 105 without additional information from a PSS of the SSB. In some examples, an SSB may include two SSS sequences of different lengths. For example, first cyclic shift information of a first SSS sequence and second cyclic shift information of a second SSS sequence (e.g., amounts by which the first and second SSS sequences are cyclically shifted) may indicate a PCID.

In some examples, an SSS of an SSB may indicate first information associated with a PCID of a network entity 105, and a PBCH of the SSB may indicate second information associated with the PCID of the network entity 105. For example, an SSS may indicate an area identifier, and a PBCH may indicate information associated with a specific cell within an area corresponding to the area identifier. In some examples, a PBCH DMRS sequence may indicate the second information associated with the PCID of a network entity 105. In examples, a MIB transmitted via a PBCH (e.g., a payload of the PBCH) may indicate the second information associated with the PCID of a network entity 105. In some examples, DMRSs of a PBCH of an SSB may indicate the PCID of a network entity 105. For example, a mapping of DMRSs to a PBCH, a density of DMRSs in a PBCH, or both, may indicate the PCID of a network entity 105. In some examples, an SSS may be transmitted as DMRSs in a PBCH. For example, an SSB may include RBs for a PSS and RBs for a PBCH, and DMRSs of the PBCH may include an SSS sequence.

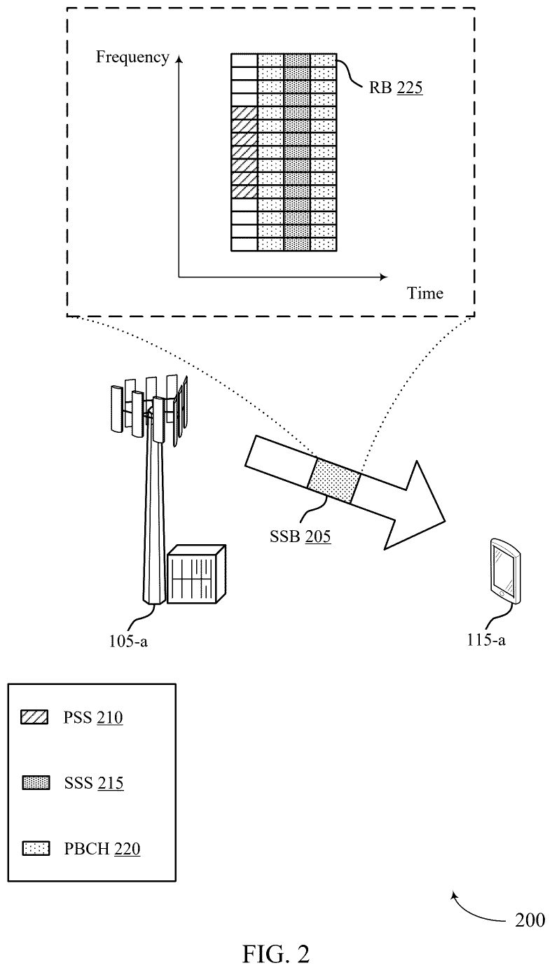

FIG. 2 shows an example of a wireless communications system 200 that supports PCID indication using synchronization signals in accordance with one or more aspects of the present disclosure. The wireless communications system 200 may implement aspects of a wireless communications system 100. For example, the wireless communications system 200 may include a UE 115-a and a network entity 105-a, which may be respective examples of a UE 115 and a network entity 105 described herein.

The network entity 105-a may periodically transmit SSBs, such as an SSB 205. The SSB 205 may include a PSS 210, an SSS 215, and a PBCH 220, each of which may be mapped to respective sets of RBs 225. In some examples, an SSB 205 may include a first signal, and a PSS 210 be an example of the first signal. Additionally, or alternatively, a DRS block may be an example of first signal. In some examples, an SSB 205 may include a second signal, and an SSS 215 may be an example of the second signal. Additionally, or alternatively, a single signal (e.g., a single synchronization signal) may be an example of the second signal.

The SSB 205 may indicate a PCID of the network entity 105-a. In some examples, the UE 115-a may receive the SSB 205 and perform time and frequency synchronization based on the PSS 210 and the SSS 215. In some examples, the UE 115-a may use the PCID of the network entity 105-a for cell selection techniques, such as an initial access procedure or a cell reselection procedure. In some examples, the PSS 210 of the SSB 205 may include a single sequence.

The wireless communications system 200 may support techniques for the SSB 205 to indicate the PCID of the network entity 105-a. In some examples, the SSS 215 of the SSB 205 may indicate the PCID of the network entity 105-a. In some examples, a combination of the SSS 215 and the PBCH 220 may indicate the PCID of the network entity 105-a. For example, the SSS 215 and DMRSs in the PBCH 220 may indicate the PCID of the network entity 105-a. Additionally, or alternatively, the SSS 215 and a payload communicated over the PBCH 220 (e.g., a MIB) may indicate the PCID of the network entity 105-a. In some examples, DMRSs in the PBCH may indicate the PCID of the network entity 105-a. Because the PSS 210 may include a single sequence, these techniques may support an indication of the PCID of the network entity 105-a without additional information conveyed by the PSS 210. For example, the SSS 215, the PBCH 220, or both, may indicate the PCID of the network entity 105 -a without additional information from the PSS 210.

In some examples, the SSS 215 may indicate the PCID of the network entity 105-a. The SSS 215 may be allocated to a larger quantity of resources than an SSS in a wireless communications systems where a PSS and an SSS indicate a PCID of a network entity 105 (e.g., together). For example, the SSS 215 may be allocated to 16 RBs 225, while an SSS in other wireless communications systems may be allocated to 12 RBs 225, such that the SSS 215 may convey additional information to indicate the PCID of the network entity 105-a.

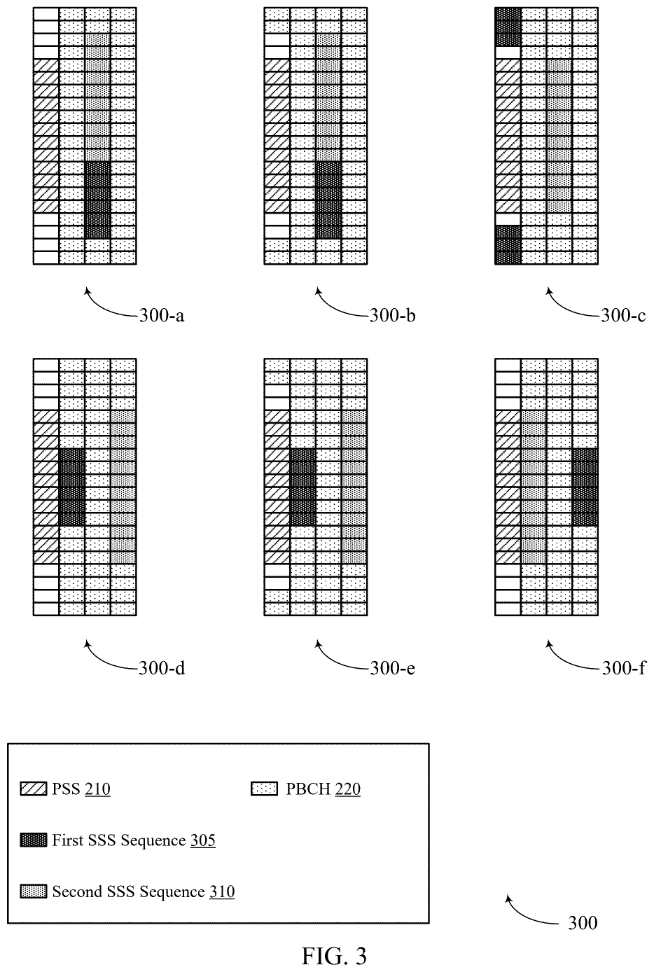

In some examples, the SSS 215 may include two SSS sequences. The SSS sequences may have different lengths. A first SSS sequence of the SSS 215 may have a first length with a first quantity of cyclic shifts (e.g., a first quantity of cyclic shift configurations), and a second SSS sequence of the SSS 215 may have a second length with a second quantity of cyclic shifts (e.g., a second quantity of cyclic shift configurations). For example, the first sequence may have a length of 63 (e.g., generated by primitive polynomials of degree 6) and be mapped to six RBs 225, and the second sequence may have a length of 127 (e.g., generated by primitive polynomials of degree 7) and be mapped to ten RBs 225. In some examples, the second quantity of cyclic shifts may be relatively larger than the first quantity of cyclic shifts. Examples of SSB configurations for an SSS 215 that includes two SSS sequences is described in more detail with reference to FIG. 3.

In some examples, an SSS 215 of an SSB 205 may include a single sequence that is mapped to two different symbols (e.g., two different symbol durations) of the SSB 205. For example, the SSS 215 may be mapped to two SSS symbols. Each SSS symbol may include 12 RBs 225. The SSS may be mapped to resources (e.g., REs) in the two SSS symbols. In some examples, the SSS sequence may be an m-sequence or Gold sequence of length 255. For example, the SSS sequence, mapped to the two SSS symbols, may indicate the PCID information of the network entity 105-a.

In some examples, the SSS 215 and the PBCH 220 may indicate the PCID of the network entity 105-a (e.g., in combination). For example, the SSS 215 may include one dedicated symbol which indicates part of the PCID (e.g., a first portion of the PCID) and the PBCH 220 may indicate part of the PCID (e.g., a second portion of the PCID.

In some examples, the SSS 215 may include part of the PCID, and the other part of the PCID may be carried by (e.g., indicated by) DMRS of the PBCH 220. In some examples, a PBCH DMRS sequence may be scrambled, or initialized, or both based on PCI information carried in the SSS 215. In some examples, a scrambling sequence for the PBCH 220 may be initialized by a cell identifier or PCID information carried in the SSS 215. In some examples, a scrambling sequence may be based on PCID information for randomization across cells. For example, a scrambling sequence may be cyclically shifted by an amount based on the PCID. For example, for an area-specific handover, the dedicated symbol for the SSS 215 may include PCI information that indicates an area identifier, and information related to a specific cell within the area may be indicated by the DMRS of the PBCH 220.

In some examples, the SSS 215 may include part of the PCID, and the other part of the PCID may be carried by (e.g., indicated by) a MIB. The MIB may be transmitted via the PBCH 220 or be an example of a payload of the PBCH 220. In some examples, the UE 115 -a may descramble a payload of the PBCH (e.g., the MIB) based on PCID information indicated by the SSS 215. If PCID information is indicated via the MIB, a PBCH DMRS sequence and the PBCH 220 may, in some examples, be scrambled or initialized based on the PCID information indicated by the SSS 215.

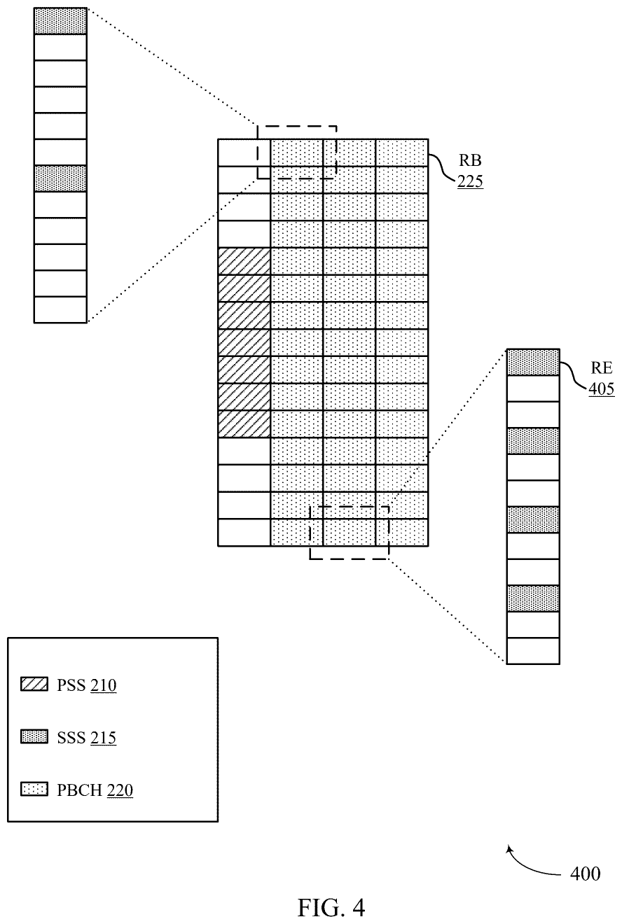

In some examples, PBCH DMRS may indicate the PCID of the network entity 105-a. In some examples, the PBCH DMRS may be non-uniformly mapped to PBCH symbols. For example, a first symbol including PBCH resources may have a first DMRS density, and a second symbol including PBCH resources may have a second DMRS density that is different from the first DMRS density. An example of PBCH DMRS indicating the PCID of a network entity 105 is described in more detail with reference to FIG. 4.

In some examples, these techniques may be implemented for an area-specific handover. For example, area-specific radio resource management (RRM) may reduce RRM measurement reporting overhead and improve handover performance, for example by reducing “ping-pong” effects where a UE 115 repeatedly selects between network entities 105 for a handover. In some examples, a PCID of a network entity 105 may include two portions of information, which may be used to support area-specific handover. For example, a first portion of information of the PCID may include area information, such as an area identifier. In some examples, the area identifier may be indicated by a first SSS sequence of an SSS 215 (e.g., if the SSS 215 includes two SSS sequences) or the SSS 215. A second portion of the information of the PCID may include cell information, such as a cell identifier. The cell identifier may be indicated by a second SSS sequence of an SSS 215 (e.g., if the SSS 215 includes two SSS sequences) or the PBCH 220 (e.g., PBCH DMRS or a MIB).

For RRM measurement, the UE 115 -a may measure a sequence related to the area ID. For example, if the UE 115 -a is performing an RRM measurement, the UE 115-a may measure a first SSS sequence (e.g., if the SSS 215 includes two sequences) and not a second SSS sequence or the PBCH 220. In some other examples, the UE 115-a may measure the SSS 215 and not the PBCH 220, such as if the first portion of PCID information is indicated by the SSS 215 and the second portion of the information is indicated by the PBCH 220.

In some examples, TCI state indication may be based on a PCID of a network entity 105. For example, the network entity 105-a or another network entity 105 may transmit control signaling to configure the UE 115-a with a TCI state associated with the network entity 105-a. The UE 115-a may receive, via the control signaling, an indication of a source reference signal for the TCI state and an indication of the PCID for the network entity 105-a.

Similar techniques may be implemented for different structures of an SSB 205. For example, an SSB 205 may include PBCH 220 and a single signal which conveys a PCID of the network entity 105-a. In some examples, the single signal may include aspects of an SSS 215. For example, the network entity 105-a may transmit a DRS block at a first periodicity and a single signal/PBCH block including the single signal at a second periodicity, and the single signal of the single signal/PBCH block may indicate the PCID of the network entity 105-a.

The UE 115-a and the network entity 105-a may establish a connection based on the SSB that indicates the PCID of the network entity 105-a. In some examples, the UE 115-a and the network entity 105-a may perform an area-specific handover based on the PCID of the network entity 105-a. For example, the UE 115-a may be handed over from a source network entity to the network entity 105-a (e.g., a target network entity). In some examples, the UE 115-a may perform an initial access procedure, including a random access procedure, to connect to the network entity 105-a based on the PCID of the network entity 105-a.

FIG. 3 shows an example of SSB configurations 300 that supports PCID indication using synchronization signals in accordance with one or more aspects of the present disclosure. Each SSB configuration 300 may be an example of a configuration for an SSB 205 as described with reference to FIG. 2.

Each SSB configuration 300 may resources that are allocated for a PSS 210, an SSS 215, and a PBCH 220, as described with reference to FIG. 2. An SSB configuration 300 may include two SSS sequences for an SSS 215 which are mapped to resources of an SSB 205. For example, an SSB configuration may include a first SSS sequence 305 and a second SSS sequence 310. In some examples, the first SSS sequence 305 have a first length, and the second SSS sequence 310 may have a second length that is greater than the first length. In some examples, the first SSS sequence 305 may be configured to be cyclically shifted by one of a first quantity of cyclic shifts, and the second SSS sequence may be configured to be cyclically shifted by one of a second quantity of cyclic shifts. In some examples, the second quantity of cyclic shifts may be larger than the first quantity of cyclic shifts.

The first SSS sequence 305 and the second SSS sequence 310 may (e.g., in combination) indicate a PCID of a network entity 105 transmitting an SSB 205 that includes the first SSS sequence 305 and the second SSS sequence 310. For example, a first cyclic shift applied to the first SSS sequence 305 and a second cyclic shift applied to the second SSS sequence 310 may indicate (e.g., be indicative of) the PCID of the network entity 105.

An SSB configuration 300-a and an SSB configuration 300-b may each use a single symbol for SSS. For example, the first SSS sequence 305 and the second SSS sequence 310 may each be mapped to a same symbol (e.g., in the time domain) in the SSB configuration 300-a and the SSB configuration 300-b. For example, the first SSS sequence 305 and the second SSS sequence 310 may be mapped to a third symbol of a four-symbol SSB.

For an SSB configuration 300-c, the first SSS sequence 305 may be mapped to a same symbol (e.g., a same symbol duration) as the PSS 210. For example, the first SSS sequence 305 and the PSS 210 may be mapped to a first symbol of a four-symbol SSB, and the second SSS sequence 310 may be mapped to a third symbol of the four-symbol SSB.

An SSB configuration 300-d, an SSB configuration 300-e, and an SSB configuration 300-f may each shown an example of a two-symbol SSS. For the SSB configuration 300-d and for the SSB configuration 300-e, the first SSS sequence 305 may be mapped to a second symbol of a four-symbol SSB, and the second SSS sequence 310 may be mapped to a fourth symbol of the four-symbol SSB. In some examples, a two-symbol SSS configuration may enable back-to-back SSS symbols, such as if PSS and SSS are transmitted according to a periodicity (e.g., a configured periodicity).

In some examples, different SSB configurations 300 may include different quantities of resource elements that are allocated for the PBCH 220. For example, the PSS 210, the first SSS sequence 305, and the second SSS sequence 310 may each be mapped to the same time/frequency resources of an SSB 205 for the SSB configuration 300-a and the SSB configuration 300-b, but the SSB configuration 300-b may include more resources allocated for the PBCH 220. In some examples, the SSB configuration 300-b, the SSB configuration 300-c, and the SSB configuration 300-e may each include a same quantity of resource elements allocated for the PBCH 220 as other SSB configurations of other systems (e.g., a same quantity of PBCH resource elements as an SSB configuration in an NR system).

FIG. 4 shows an example of a DMRS mapping configuration 400 that supports PCID indication using synchronization signals in accordance with one or more aspects of the present disclosure. The DMRS mapping configuration 400 may be configured for an SSB 205 as described with reference to FIG. 2. The SSB 205 may include a PSS 210, an SSS 215, and a PBCH 220 as described with reference to FIG. 2.

Some wireless communications systems support a uniform mapping of DMRSs in PBCH resources of an SSB 205. For example, a DMRS density in some wireless communications may be ¼, where a DMRS is transmitted via each fourth resource element of time or frequency resources allocated for a PBCH 220. In some examples, this may correspond to allocated 144 resource elements for PBCH DMRS. DMRS may indicate (e.g., carry) up to three bits of an SSB index (e.g., corresponding to the SSB 205).

The DMRS mapping configuration 400 shows an example of indicating a PCID of a network entity 105 via DMRS of the PBCH 220. For example, the PCID of the network entity 105 may be indicated exclusively through the DMRS of the PBCH (e.g., without additional information from a PSS 210). If PCID is indicated via PBCH DMRS, some techniques to allocate resources for PBCH DMRS may not include sufficient resources to indicate the PCID of the network entity 105. For example, the DMRS mapping configuration 400 may show an example of allocating more than 144 resource elements for PBCH DMRS.

In some examples, the SSS 215 may be transmitted as the DMRS of the PBCH 220. For example, the SSS 215 may be mapped to resource elements 405 of an RB 225 of the PBCH 220. To support a similar quantity of resource elements allocated for SSS as other schemes, 200 resource elements may be allocated for PBCH DMRS (e.g., and thus the SSS 215). Using a PBCH DMRS density of ¼ may allocate 180 resource elements for PBCH DMRS, and using a PBCH DMRS density of ⅓ may allocate 240 resource elements for PBCH DMRS. To support a balance between PBCH DMRS detection and PBCH decoding performance, the DMRS mapping configuration 400 may support non-uniform DMRS mapping across different PBCH symbols.

For example, a first symbol and a last symbol including PBCH resources may have a first DMRS density, and a middle symbol including PBCH resources may have a second DMRS density that is different from the first DMRS density. For example, a second symbol of an SSB 205 (e.g., a first symbol that includes PBCH resources in some examples) and a fourth symbol of the SSB 205 (e.g., a last symbol that includes PBCH resources in some examples) may have a DMRS density of ⅓, such that the second symbol and the fourth symbol of the SSB 205 include 160 resource elements allocated for DMRS. A third symbol of the SSB (e.g., a middle symbol that includes PBCH resources in some examples) may have a DMRS density of ⅙, such that the third symbol of the SSB 205 includes 40 resource elements allocated for DMRS. In this example, the SSB 205 may include 200 resource elements allocated for DMRS.

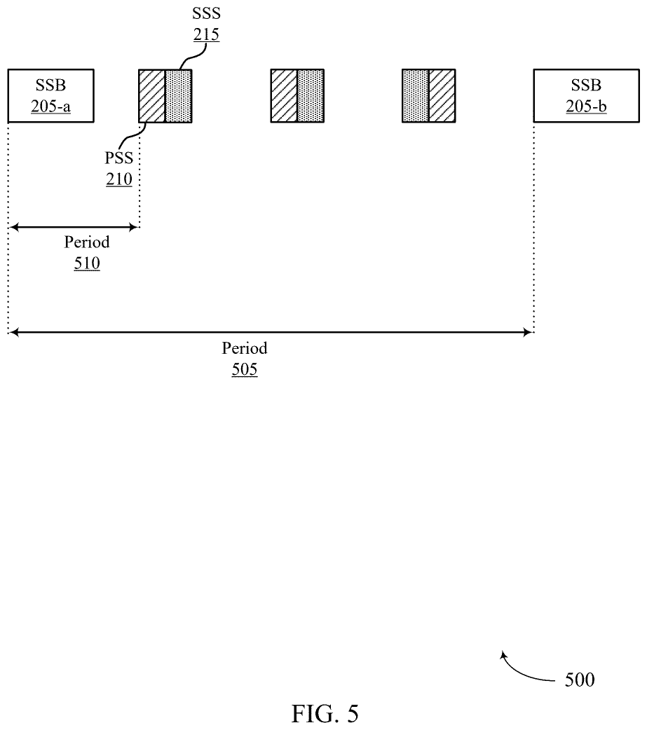

FIG. 5 shows an example of an SSB periodicity configuration 500 that supports PCID indication using synchronization signals in accordance with one or more aspects of the present disclosure.

A network entity 105 may periodically transmit SSBs 205. For example, the network entity 105 may transmit SSBs 205 in accordance with a periodicity of 20 milliseconds. In some examples, the network entity 105 may transmit an SSB 205 including resources allocated for PBCH with a different periodicity than an SSB 205 that does not include resources allocated for PBCH. For example, the network entity 105 may transmit an SSB 205 including PBCH according to a first periodicity (e.g., corresponding to a period 505). For example, the network entity 105 may transmit an SSB 205-a and, after the period 505, the network entity 105 may transmit an SSB 205-b. The network entity 105 may transmit an SSB without PBCH according to a second periodicity (e.g., corresponding to a period 510). For example, the network entity 105 may transmit a PSS 210 and an SSS 215 (e.g., an SSB 205 without PBCH resources) in accordance with a periodicity of X milliseconds, and the network entity 105 may transmit an SSB 205 (e.g., including a PSS 210, and SSS 215, and a PBCH 220) in accordance with a periodicity of Y milliseconds.

In some examples, the techniques described herein may be implemented for an area-specific handover. For example, a network entity 105 may transmit an SSB that indicates a PCID of the network entity 105 via an SSS 215 or a PBCH 220, or both, without additional information from a PSS 210. If the PSS 210 and the SSS 215 are transmitted with a same periodicity, and that periodicity is shorter than a PBCH periodicity, the SSS 215 may indicate an area identifier associated with the network entity 105. For example, a transmission including the PSS 210 and the SSS 215 may indicate the area identifier of the network entity 105 and not, for example, a cell identifier of the network entity 105.

In some examples, a network entity 105 may transmit a PSS block at a first periodicity and an SSS/PBCH block at a second periodicity. For example, the network entity 105 may transmit a PSS block, including one or more PSS 210, according to the first periodicity that corresponds to the period 505. The network entity 105 may transmit an SSS block, including one or more SSS 215 and one or more PBCH 220, according to the second periodicity that corresponds to the period 510. In some examples, the SSS block transmitted according to the second periodicity, including an SSS 215 and a PBCH 220, may indicate a PCID of the network entity 105 according to the techniques described herein.

In some examples, a network entity 105 may transmit a DRS block at a first periodicity and an SSB 205 at a second periodicity. For example, the network entity 105 may transmit a DRS block, including one or more DRS, according to the first periodicity that corresponds to the period 505. The network entity 105 may transmit an SSB (e.g., an SS/PBCH block), including one or more PSS 210, one or more SSS 215, and one or more PBCH 220, according to the second periodicity that corresponds to the period 510. In some examples, an SS/PBCH block transmitted according to the second periodicity, including a PSS 210, an SSS 215, and a PBCH 220, may indicate a PCID of the network entity 105 according to the techniques described herein.

In some examples, a network entity 105 may transmit a DRS block at a first periodicity and an SSB (e.g., an SS/PBCH block) at a second periodicity. For example, the network entity 105 may transmit a DRS block, including one or more DRS, according to the first periodicity that corresponds to the period 505. The network entity 105 may transmit an SS/PBCH block, including one or more second signals and one or more PBCH 220, according to the second periodicity that corresponds to the period 510. In some examples, the second signal of an SS/PBCH block may indicate the PCID of the network entity 105.

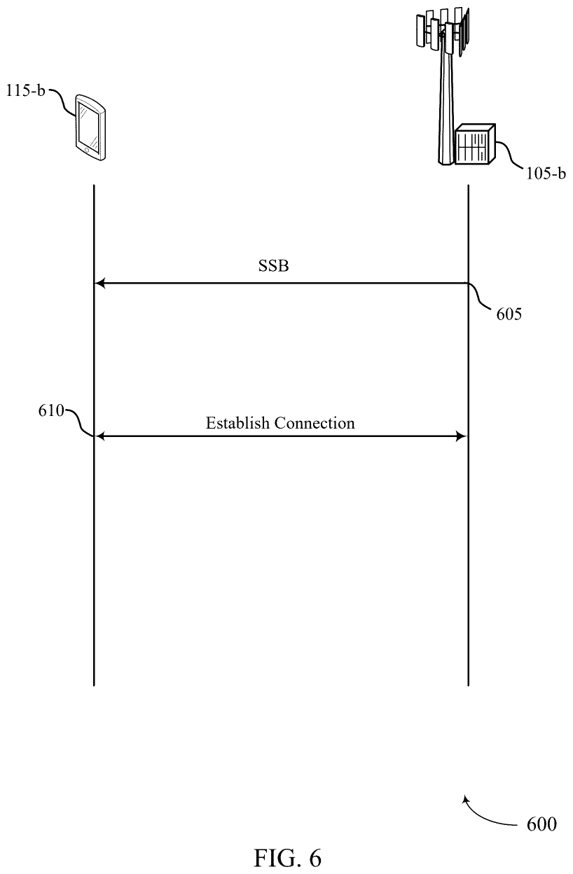

FIG. 6 shows an example of a process flow 600 that supports PCID indication using synchronization signals in accordance with one or more aspects of the present disclosure. The process flow 600 may implement aspects of a wireless communications system 100 and a wireless communications system 200 as described with reference to FIGS. 1 and 2. For example, the process flow 600 may be implemented by a UE 115-b or a network entity 105-b, or both, which may be respective examples of a UE 115 and a network entity 105 described herein.

Alternative examples of the following may be implemented, where some steps are performed in a different order than described or are not performed at all. In some cases, steps may include additional features not mentioned below, or further steps may be added. Although the UE 115-b and the network entity 105-b are shown performing the operations of the process flow 600, some aspects of some operations may also be performed by one or more other wireless devices.

At 605, the network entity 105-b may output, an SSB including a first signal, a second signal, and a PBCH, which may be received by the UE 115-b. In some examples, the first signal may include a PSS. In some other examples, the first signal may include a DRS or a DRS block. In some examples, the second signal may include an SSS. In some other examples, the second signal may include a single signal (e.g., a single synchronization signal). The SSB may indicate a PCID of the network entity 105-b. In some examples, the second signal and the PBCH may indicate the PCID of the network entity 105-b, for example without additional information from the PSS. In some examples, the second signal may indicate the PCID of the network entity 105-b, for example without additional information from the PSS.

In some examples, the second signal may indicate first information associated with the PCID of the network entity 105-b, and the PBCH may indicate second information associated with the PCID of the network entity 105-b. For example, the second signal may indicate an area identifier for an area including the network entity 105-b (e.g., an area in which the network entity 105-b is operating), and the PBCH may indicate a cell identifier within the area.

In some examples, the network entity 105-b may output, one or more DMRS of the PBCH, which may be received by the UE 115-b, and the one or more DMRS may indicate the second information associated with the PCID of the network entity 105-b. The UE 115-b may descramble the one or more DMRS of the PBCH based on the first information associated with the PCID. In some examples, the network entity 105-b may output a MIB via the PBCH, which may be received by the UE 115-b, and the MIB may indicate the second information associated with the PCID. In some examples, the UE 115-b may descramble the MIB based on the first information associated with the PCID.

In some examples, the second signal may indicate the PCID of the network entity 105-b, for example without additional information from the PSS. In some examples, an SSS may include a first sequence that is mapped to a first set of resource elements and a second sequence that is mapped to a second set of resource elements. The first sequence and the second sequence may indicate the PCID of the network entity 105 -b. For example, a first cyclic shift applied to the first sequence and a second cyclic shift applied to the second sequence may indicate the PCID of the network entity 105-b. In some examples, the first sequence of the SSS may indicate an area identifier for an area including the network entity 105-b, and the second sequence of the SSS may indicate a cell identifier within the area.

In some examples, the second signal of the SSB may include a single sequence that is mapped to two different symbols of the SSB. For example, the second signal may be mapped to two symbols (e.g., two SSS symbols). Each symbol may include 12 RBs. The second signal may be mapped to resources (e.g., REs) in the two symbols. In some examples, a sequence of the second signal may be an m-sequence or Gold sequence having a length of 255. For example, the sequence (e.g., the SSS sequence), mapped to the two symbols (e.g., the two SSS symbols), may indicate the PCID information of the network entity 105-b.

In some examples, the network entity 105-b may output a set of multiple DMRS of a PBCH that includes the second signal, which may be received by the UE 115-b. For example, the second signal may be transmitted as the DMRSs of the PBCH. In some examples, a mapping of the set of multiple DMRSs to resource elements of the SSB may indicate the PCID of the network entity 105-b. Additionally, or alternatively, a DMRS sequence of the PBCH may indicate the PCID of the network entity 105-b. In some examples, the set of multiple DMRSs may non-uniformly mapped to symbols of the SSB. For example, a first symbol index of the first SSB may be associated with a first DMRS density, and a second symbol index of the SSB may be associated with a second DMRS density.

At 610, the UE 115-b or the network entity 105-b, or both, may perform a connection establishment procedure. For example, the UE 115-b and the network entity 105-b may establish a connection based on the PCID of the network entity 105-b. In some examples, the UE 115-b may perform an area-specific handover procedure (e.g., to be handed over to the network entity 105-b) based on the PCID of the network entity 105-b. For example, the PCID of the network entity 105-b including an area identifier and a cell identifier may enable the area-specific handover to the network entity 105-b. In some examples, the UE 115-b may perform an initial access procedure to connect with the network entity 105-b based on the PCID.

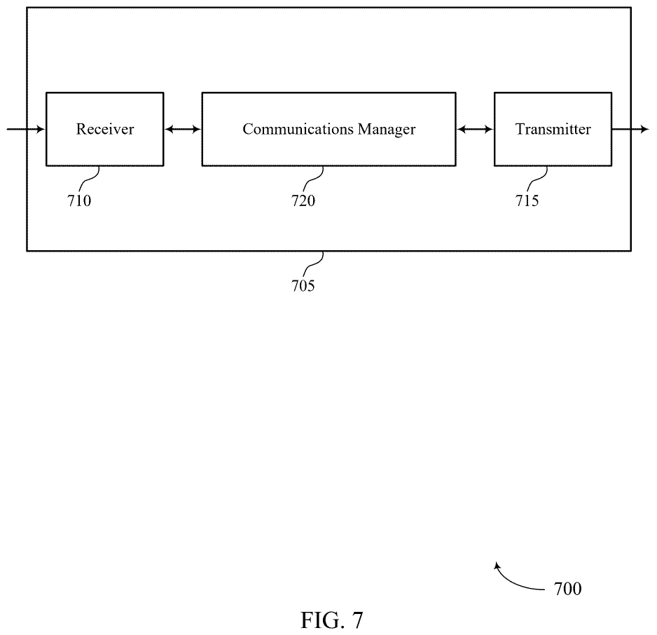

FIG. 7 shows a block diagram 700 of a device 705 that supports PCID indication using synchronization signals in accordance with one or more aspects of the present disclosure. The device 705 may be an example of aspects of a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to PCID indication using synchronization signals). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to PCID indication using synchronization signals). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations or components thereof may be examples of means for performing various aspects of PCID indication using synchronization signals as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor (e.g., referred to as a processor-executable code). If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. For example, the communications manager 720 is capable of, configured to, or operable to support a means for receiving an SSB including a first signal, a second signal, and a PBCH, the second signal indicating first information associated with a PCID of a network entity, and the PBCH indicating second information associated with the PCID of the network entity. The communications manager 720 is capable of, configured to, or operable to support a means for establishing a connection with the network entity based on a determination of the PCID of the network entity in accordance with the first information and the second information.

Additionally, or alternatively, the communications manager 720 may support wireless communications in accordance with examples as disclosed herein. For example, the communications manager 720 is capable of, configured to, or operable to support a means for receiving an SSB including a first signal and a second signal, the second signal indicating a PCID of a network entity without additional information from the first signal. The communications manager 720 is capable of, configured to, or operable to support a means for establishing a connection with the network entity based on the PCID of the network entity.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for reduced processing and more efficient utilization of communication resources.

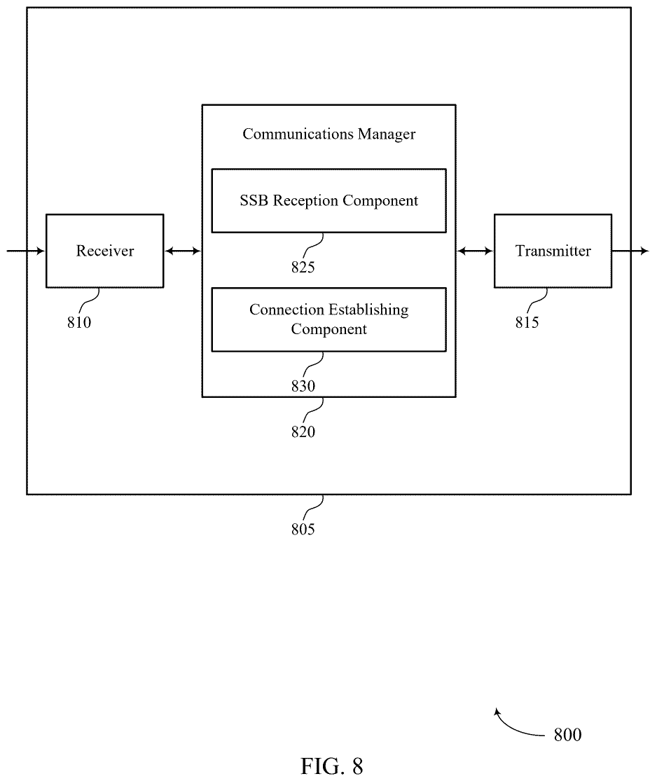

FIG. 8 shows a block diagram 800 of a device 805 that supports PCID indication using synchronization signals in accordance with one or more aspects of the present disclosure. The device 805 may be an example of aspects of a device 705 or a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to PCID indication using synchronization signals). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to PCID indication using synchronization signals). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of PCID indication using synchronization signals as described herein. For example, the communications manager 820 may include an SSB reception component 825 a connection establishing component 830, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. The SSB reception component 825 is capable of, configured to, or operable to support a means for receiving an SSB including a first signal, a second signal, and a PBCH, the second signal indicating first information associated with a PCID of a network entity, and the PBCH indicating second information associated with the PCID of the network entity. The connection establishing component 830 is capable of, configured to, or operable to support a means for establishing a connection with the network entity based on a determination of the PCID of the network entity in accordance with the first information and the second information.

Additionally, or alternatively, the communications manager 820 may support wireless communications in accordance with examples as disclosed herein. The SSB reception component 825 is capable of, configured to, or operable to support a means for receiving an SSB including a first signal and a second signal, the second signal indicating a PCID of a network entity without additional information from the first signal. The connection establishing component 830 is capable of, configured to, or operable to support a means for establishing a connection with the network entity based on the PCID of the network entity.

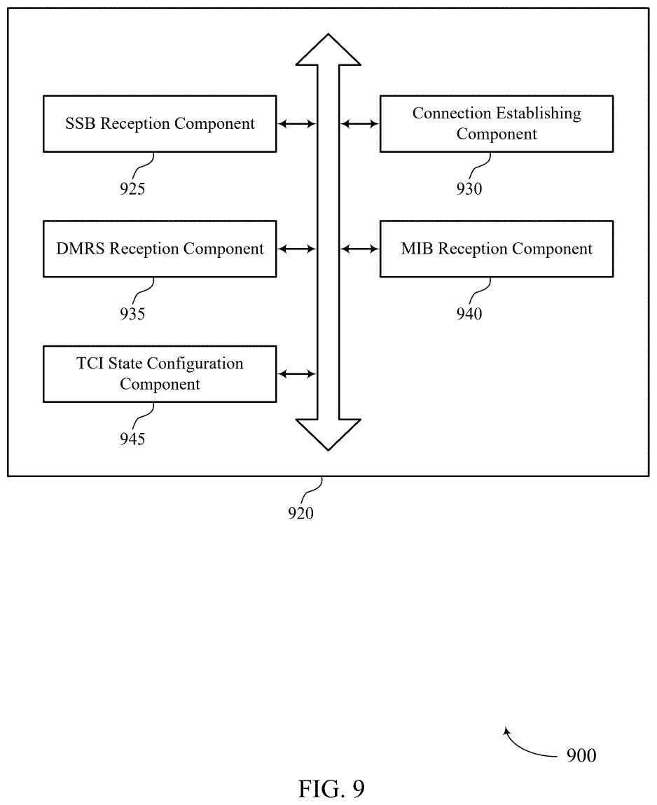

FIG. 9 shows a block diagram 900 of a communications manager 920 that supports PCID indication using synchronization signals in accordance with one or more aspects of the present disclosure. The communications manager 920 may be an example of aspects of a communications manager 720, a communications manager 820, or both, as described herein. The communications manager 920, or various components thereof, may be an example of means for performing various aspects of PCID indication using synchronization signals as described herein. For example, the communications manager 920 may include an SSB reception component 925, a connection establishing component 930, a DMRS reception component 935, a MIB reception component 940, a TCI state configuration component 945, or any combination thereof. Each of these components, or components or subcomponents thereof (e.g., one or more processors, one or more memories), may communicate, directly or indirectly, with one another (e.g., via one or more buses).

The communications manager 920 may support wireless communications in accordance with examples as disclosed herein. The SSB reception component 925 is capable of, configured to, or operable to support a means for receiving an SSB including a first signal, a second signal, and a PBCH, the second signal indicating first information associated with a PCID of a network entity, and the PBCH indicating second information associated with the PCID of the network entity. The connection establishing component 930 is capable of, configured to, or operable to support a means for establishing a connection with the network entity based on a determination of the PCID of the network entity in accordance with the first information and the second information.

In some examples, to support receiving the SSB, the DMRS reception component 935 is capable of, configured to, or operable to support a means for receiving one or more DMRSs of the PBCH indicating the second information associated with the PCID.

In some examples, the DMRS reception component 935 is capable of, configured to, or operable to support a means for descrambling the one or more DMRSs of the PBCH based on the first information associated with the PCID, the determination of the PCID being based on descrambling the one or more DMRSs.

In some examples, to support receiving the SSB, the MIB reception component 940 is capable of, configured to, or operable to support a means for receiving a master information block via the PBCH, the master information block indicating the second information associated with the PCID.

In some examples, the first signal includes a PSS. In some examples, the first signal includes a PSS block. In some examples, the first signal includes a DRS. In some examples, the first signal includes a DRS block.

In some examples, the second signal includes an SSS. In some examples, the second signal includes an SSS/PBCH block. In some examples, the second signal includes an SSB. In some examples, the second signal includes an SS/PBCH block.

In some examples, the PCID of the network entity includes an area identifier and a cell identifier.

In some examples, the first information indicated by the second signal includes the area identifier and the second information indicated by the PBCH includes the cell identifier.

In some examples, the TCI state configuration component 945 is capable of, configured to, or operable to support a means for receiving control information indicating a transmission configuration indicator state, the control information including the PCID associated with the network entity and a source reference signal associated with the transmission configuration indicator state.

Additionally, or alternatively, the communications manager 920 may support wireless communications in accordance with examples as disclosed herein. In some examples, the SSB reception component 925 is capable of, configured to, or operable to support a means for receiving an SSB including a first signal and a second signal, the second signal indicating a PCID of a network entity without additional information from the PSS. In some examples, the connection establishing component 930 is capable of, configured to, or operable to support a means for establishing a connection with the network entity based on the PCID of the network entity.

In some examples, the second signal includes a first sequence that is mapped to a first set of resource elements and a second sequence that is mapped to a second set of resource elements, the first sequence and the second sequence indicating the PCID of the network entity.

In some examples, the first set of resource elements includes a first quantity of resource elements, and the second set of resource elements includes a second quantity of resource elements that is different from the first quantity of resource elements.

In some examples, the first set of resource elements corresponds to a first symbol index of the SSB, and the second set of resource elements corresponds to a second symbol index of the SSB that is different from the first symbol index.

In some examples, the first set of resource elements and the second set of resource elements correspond to a same symbol index of the SSB.

In some examples, a first cyclic shift applied to the first sequence and a second cyclic shift applied to the second sequence indicate the PCID of the network entity.

In some examples, to support receiving the SSB, the DMRS reception component 935 is capable of, configured to, or operable to support a means for receiving a set of multiple DMRSs of a PBCH including the second signal, a mapping of the set of multiple DMRSs to resource elements of the SSB indicating the PCID of the network entity.

In some examples, a first symbol index of the SSB is associated with a first DMRS density, and a second symbol index of the SSB is associated with a second DMRS density.

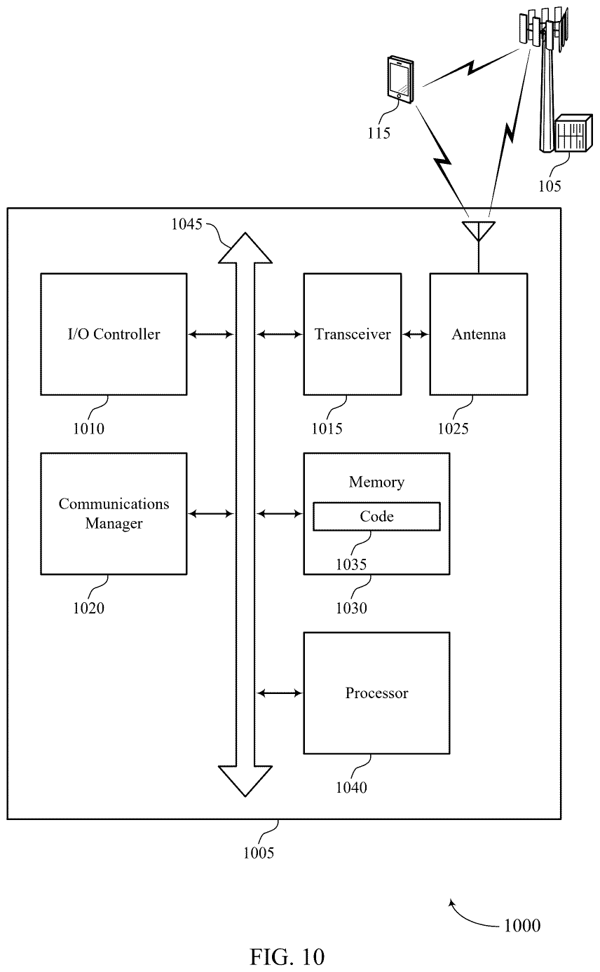

FIG. 10 shows a diagram of a system 1000 including a device 1005 that supports PCID indication using synchronization signals in accordance with one or more aspects of the present disclosure. The device 1005 may be an example of or include components of a device 705, a device 805, or a UE 115 as described herein. The device 1005 may communicate (e.g., wirelessly) with one or more other devices (e.g., network entities 105, UEs 115, or a combination thereof). The device 1005 may include components for bi-directional voice and data communications including components for transmitting and receiving communications, such as a communications manager 1020, an input/output (I/O) controller, such as an I/O controller 1010, a transceiver 1015, one or more antennas 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna. However, in some other cases, the device 1005 may have more than one antenna, which may be capable of concurrently transmitting or receiving multiple wireless transmissions. The transceiver 1015 may communicate bi-directionally via the one or more antennas 1025 using wired or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include random access memory (RAM) and read-only memory (ROM). The at least one memory 1030 may store computer-readable, computer-executable, or processor-executable code, such as the code 1035. The code 1035 may include instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may include, among other things, a basic I/O system (BIOS) which may control basic hardware or software operation such as the interaction with peripheral components or devices.

The at least one processor 1040 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting PCID indication using synchronization signals). For example, the device 1005 or a component of the device 1005 may include at least one processor 1040 and at least one memory 1030 coupled with or to the at least one processor 1040, the at least one processor 1040 and the at least one memory 1030 configured to perform various functions described herein.

In some examples, the at least one processor 1040 may include multiple processors and the at least one memory 1030 may include multiple memories. One or more of the multiple processors may be coupled with one or more of the multiple memories, which may, individually or collectively, be configured to perform various functions described herein. In some examples, the at least one processor 1040 may be a component of a processing system, which may refer to a system (such as a series) of machines, circuitry (including, for example, one or both of processor circuitry (which may include the at least one processor 1040) and memory circuitry (which may include the at least one memory 1030), or components, that receives or obtains inputs and processes the inputs to produce, generate, or obtain a set of outputs. The processing system may be configured to perform one or more of the functions described herein. For example, the at least one processor 1040 or a processing system including the at least one processor 1040 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code 1035 (e.g., processor-executable code) stored in the at least one memory 1030 or otherwise, to perform one or more of the functions described herein.

The communications manager 1020 may support wireless communications in accordance with examples as disclosed herein. For example, the communications manager 1020 is capable of, configured to, or operable to support a means for receiving an SSB including a first signal, a second signal, and a PBCH, the second signal indicating first information associated with a PCID of a network entity, and the PBCH indicating second information associated with the PCID of the network entity. The communications manager 1020 is capable of, configured to, or operable to support a means for establishing a connection with the network entity based on a determination of the PCID of the network entity in accordance with the first information and the second information.

Additionally, or alternatively, the communications manager 1020 may support wireless communications in accordance with examples as disclosed herein. For example, the communications manager 1020 is capable of, configured to, or operable to support a means for receiving an SSB including a first signal and a second signal, the second signal indicating a PCID of a network entity without additional information from the first signal. The communications manager 1020 is capable of, configured to, or operable to support a means for establishing a connection with the network entity based on the PCID of the network entity.

By including or configuring the communications manager 1020 in accordance with examples as described herein, the device 1005 may support techniques for improved communication reliability, more efficient utilization of communication resources, and improved coordination between devices.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of PCID indication using synchronization signals as described herein, or the at least one processor 1040 and the at least one memory 1030 may be otherwise configured to, individually or collectively, perform or support such operations.

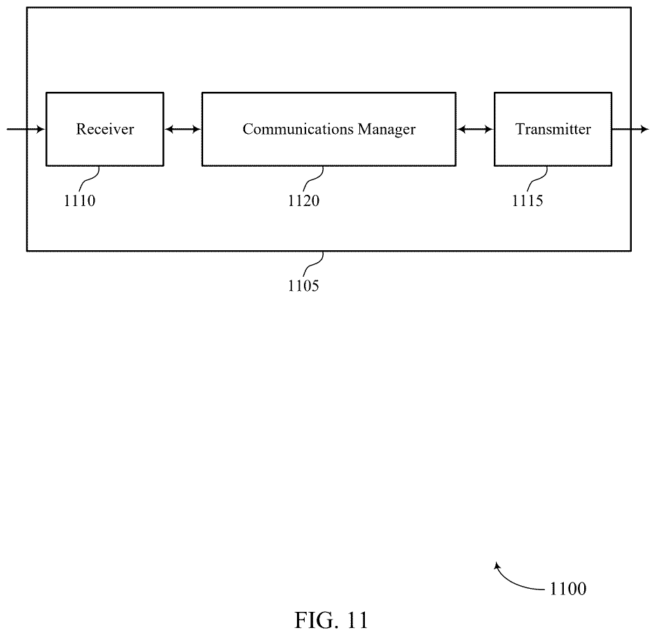

FIG. 11 shows a block diagram 1100 of a device 1105 that supports PCID indication using synchronization signals in accordance with one or more aspects of the present disclosure. The device 1105 may be an example of aspects of a network entity 105 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to, individually or collectively, support or enable the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations or components thereof may be examples of means for performing various aspects of PCID indication using synchronization signals as described herein. For example, the communications manager 1120, the receiver 1110, the transmitter 1115, or various combinations or components thereof may be capable of performing one or more of the functions described herein.

In some examples, the communications manager 1120, the receiver 1110, the transmitter 1115, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1120, the receiver 1110, the transmitter 1115, or various combinations or components thereof may be implemented in code (e.g., as communications management software or firmware) executed by at least one processor (e.g., referred to as a processor-executable code). If implemented in code executed by at least one processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. For example, the communications manager 1120 is capable of, configured to, or operable to support a means for outputting an SSB including a first signal, a second signal, and a PBCH, the second signal indicating first information associated with a PCID of the network entity, and the PBCH indicating second information associated with the PCID of the network entity. The communications manager 1120 is capable of, configured to, or operable to support a means for establishing a connection with a UE based on outputting the SSB.

Additionally, or alternatively, the communications manager 1120 may support wireless communications in accordance with examples as disclosed herein. For example, the communications manager 1120 is capable of, configured to, or operable to support a means for outputting an SSB including a first signal and a second signal, the second signal indicating a PCID of the network entity without additional information from the PSS. The communications manager 1120 is capable of, configured to, or operable to support a means for establishing a connection with a UE based on the PCID of the network entity.

By including or configuring the communications manager 1120 in accordance with examples as described herein, the device 1105 (e.g., at least one processor controlling or otherwise coupled with the receiver 1110, the transmitter 1115, the communications manager 1120, or a combination thereof) may support techniques for reduced processing and more efficient utilization of communication resources.

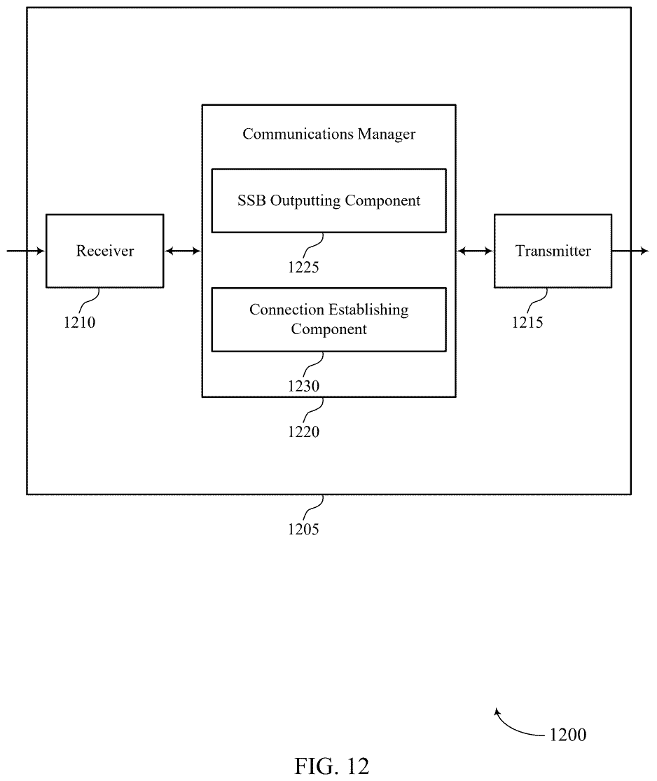

FIG. 12 shows a block diagram 1200 of a device 1205 that supports PCID indication using synchronization signals in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205, or one or more components of the device 1205 (e.g., the receiver 1210, the transmitter 1215, the communications manager 1220), may include at least one processor, which may be coupled with at least one memory, to support the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of PCID indication using synchronization signals as described herein. For example, the communications manager 1220 may include an SSB outputting component 1225 a connection establishing component 1230, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. The SSB outputting component 1225 is capable of, configured to, or operable to support a means for outputting an SSB including a first signal, a second signal, and a PBCH, the second signal indicating first information associated with a PCID of the network entity, and the PBCH indicating second information associated with the PCID of the network entity. The connection establishing component 1230 is capable of, configured to, or operable to support a means for establishing a connection with a UE based on outputting the SSB.

Additionally, or alternatively, the communications manager 1220 may support wireless communications in accordance with examples as disclosed herein. The SSB outputting component 1225 is capable of, configured to, or operable to support a means for outputting an SSB including a first signal and a second signal, the second signal indicating a PCID of the network entity without additional information from the first signal. The connection establishing component 1230 is capable of, configured to, or operable to support a means for establishing a connection with a UE based on the PCID of the network entity.

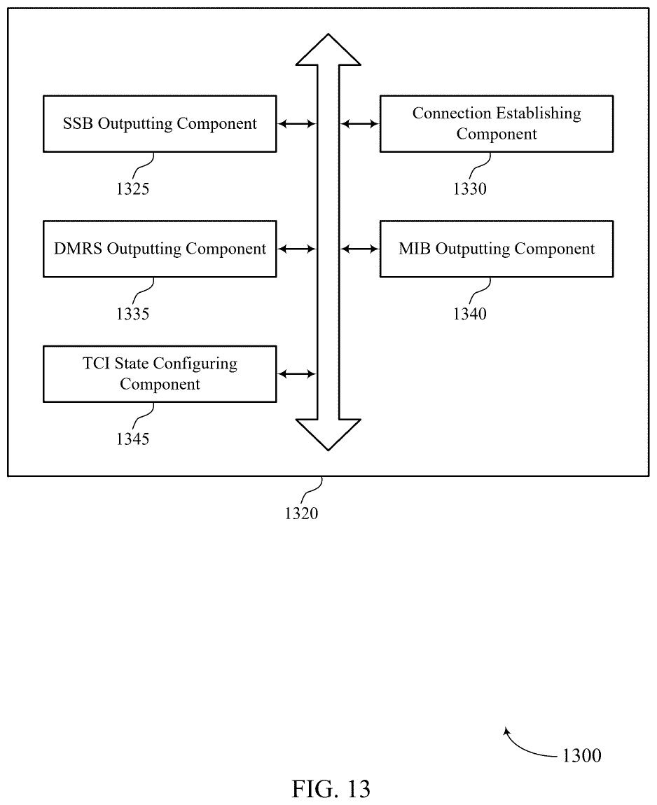

FIG. 13 shows a block diagram 1300 of a communications manager 1320 that supports PCID indication using synchronization signals in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of PCID indication using synchronization signals as described herein. For example, the communications manager 1320 may include an SSB outputting component 1325, a connection establishing component 1330, a DMRS outputting component 1335, a MIB outputting component 1340, a TCI state configuring component 1345, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communications in accordance with examples as disclosed herein. The SSB outputting component 1325 is capable of, configured to, or operable to support a means for outputting an SSB including a first signal, a second signal, and a PBCH, the second signal indicating first information associated with a PCID of the network entity, and the PBCH indicating second information associated with the PCID of the network entity. The connection establishing component 1330 is capable of, configured to, or operable to support a means for establishing a connection with a UE based on outputting the SSB.

In some examples, to support outputting the SSB, the DMRS outputting component 1335 is capable of, configured to, or operable to support a means for outputting one or more DMRSs of the PBCH indicating the second information associated with the PCID.

In some examples, the DMRS outputting component 1335 is capable of, configured to, or operable to support a means for scrambling the one or more DMRSs of the PBCH based on the first information associated with the PCID.

In some examples, the first signal includes a PSS. In some examples, the first signal includes a PSS block. In some examples, the first signal includes a DRS. In some examples, the first signal includes a DRS block.

In some examples, the second signal includes an SSS. In some examples, the second signal includes an SSS/PBCH block. In some examples, the second signal includes an SSB. In some examples, the second signal includes an SS/PBCH block.

In some examples, to support outputting the SSB, the MIB outputting component 1340 is capable of, configured to, or operable to support a means for outputting a master information block via the PBCH, the master information block indicating the second information associated with the PCID.

In some examples, the PCID of the network entity includes an area identifier and a cell identifier.

In some examples, the first information indicated by the second signal includes the area identifier and the second information indicated by the PBCH includes the cell identifier.

In some examples, the TCI state configuring component 1345 is capable of, configured to, or operable to support a means for outputting control information indicating a transmission configuration indicator state, the control information including the PCID associated with the network entity and a source reference signal associated with the transmission configuration indicator state.

Additionally, or alternatively, the communications manager 1320 may support wireless communications in accordance with examples as disclosed herein. In some examples, the SSB outputting component 1325 is capable of, configured to, or operable to support a means for outputting an SSB including a first signal and a second signal, the second signal indicating a PCID of the network entity without additional information from the first signal. In some examples, the connection establishing component 1330 is capable of, configured to, or operable to support a means for establishing a connection with a UE based on the PCID of the network entity.

In some examples, the second signal includes a first sequence that is mapped to a first set of resource elements and a second sequence that is mapped to a second set of resource elements, the first sequence and the second sequence indicating the PCID of the network entity.

In some examples, the first set of resource elements includes a first quantity of resource elements, and the second set of resource elements includes a second quantity of resource elements that is different from the first quantity of resource elements.

In some examples, the first set of resource elements corresponds to a first symbol index of the SSB, and the second set of resource elements corresponds to a second symbol index of the SSB that is different from the first symbol index.

In some examples, the first set of resource elements and the second set of resource elements correspond to a same symbol index of the SSB.

In some examples, a first cyclic shift applied to the first sequence and a second cyclic shift applied to the second sequence indicate the PCID of the network entity.

In some examples, to support outputting the SSB, the DMRS outputting component 1335 is capable of, configured to, or operable to support a means for outputting a set of multiple DMRSs of a PBCH including the second signal, a mapping of the set of multiple DMRSs to resource elements of the SSB indicating the PCID of the network entity.

In some examples, a first symbol index of the SSB is associated with a first DMRS density, and a second symbol index of the SSB is associated with a second DMRS density.

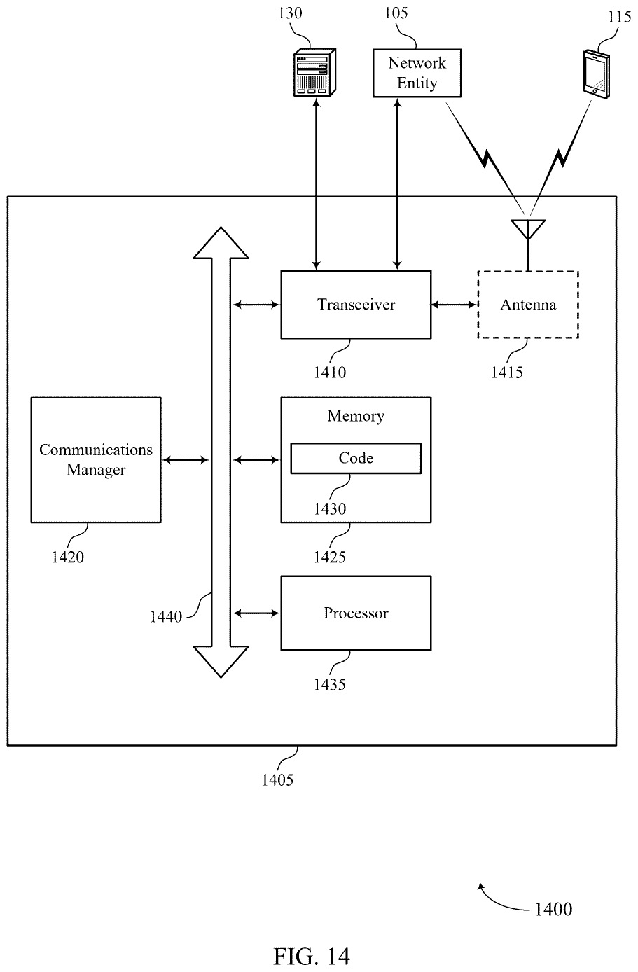

FIG. 14 shows a diagram of a system 1400 including a device 1405 that supports PCID indication using synchronization signals in accordance with one or more aspects of the present disclosure. The device 1405 may be an example of or include components of a device 1105, a device 1205, or a network entity 105 as described herein. The device 1405 may communicate with other network devices or network equipment such as one or more of the network entities 105, UEs 115, or any combination thereof. The communications may include communications over one or more wired interfaces, over one or more wireless interfaces, or any combination thereof. The device 1405 may include components that support outputting and obtaining communications, such as a communications manager 1420, a transceiver 1410, one or more antennas 1415, at least one memory 1425, code 1430, and at least one processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or one or more memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or one or more memory components (e.g., the at least one processor 1435, the at least one memory 1425, or both), may be included in a chip or chip assembly that is installed in the device 1405. In some examples, the transceiver 1410 may be operable to support communications via one or more communications links (e.g., communication link(s) 125, backhaul communication link(s) 120, a midhaul communication link 162, a fronthaul communication link 168).

The at least one memory 1425 may include RAM, ROM, or any combination thereof. The at least one memory 1425 may store computer-readable, computer-executable, or processor-executable code, such as the code 1430. The code 1430 may include instructions that, when executed by one or more of the at least one processor 1435, cause the device 1405 to perform various functions described herein. The code 1430 may be stored in a non-transitory computer-readable medium such as system memory or another type of memory. In some cases, the code 1430 may not be directly executable by a processor of the at least one processor 1435 but may cause a computer (e.g., when compiled and executed) to perform functions described herein. In some cases, the at least one memory 1425 may include, among other things, a BIOS which may control basic hardware or software operation such as the interaction with peripheral components or devices. In some examples, the at least one processor 1435 may include multiple processors and the at least one memory 1425 may include multiple memories. One or more of the multiple processors may be coupled with one or more of the multiple memories which may, individually or collectively, be configured to perform various functions herein (for example, as part of a processing system).

The at least one processor 1435 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1435 may be configured to operate a memory array using a memory controller. In some other cases, a memory controller may be integrated into one or more of the at least one processor 1435. The at least one processor 1435 may be configured to execute computer-readable instructions stored in a memory (e.g., one or more of the at least one memory 1425) to cause the device 1405 to perform various functions (e.g., functions or tasks supporting PCID indication using synchronization signals). For example, the device 1405 or a component of the device 1405 may include at least one processor 1435 and at least one memory 1425 coupled with one or more of the at least one processor 1435, the at least one processor 1435 and the at least one memory 1425 configured to perform various functions described herein. The at least one processor 1435 may be an example of a cloud-computing platform (e.g., one or more physical nodes and supporting software such as operating systems, virtual machines, or container instances) that may host the functions (e.g., by executing code 1430) to perform the functions of the device 1405. The at least one processor 1435 may be any one or more suitable processors capable of executing scripts or instructions of one or more software programs stored in the device 1405 (such as within one or more of the at least one memory 1425).

In some examples, the at least one processor 1435 may include multiple processors and the at least one memory 1425 may include multiple memories. One or more of the multiple processors may be coupled with one or more of the multiple memories, which may, individually or collectively, be configured to perform various functions herein. In some examples, the at least one processor 1435 may be a component of a processing system, which may refer to a system (such as a series) of machines, circuitry (including, for example, one or both of processor circuitry (which may include the at least one processor 1435) and memory circuitry (which may include the at least one memory 1425)), or components, that receives or obtains inputs and processes the inputs to produce, generate, or obtain a set of outputs. The processing system may be configured to perform one or more of the functions described herein. For example, the at least one processor 1435 or a processing system including the at least one processor 1435 may be configured to, configurable to, or operable to cause the device 1405 to perform one or more of the functions described herein. Further, as described herein, being “configured to,” being “configurable to,” and being “operable to” may be used interchangeably and may be associated with a capability, when executing code stored in the at least one memory 1425 or otherwise, to perform one or more of the functions described herein.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the at least one memory 1425, the code 1430, and the at least one processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with one or more other network entities 105, and may include a controller or scheduler for controlling communications with UEs 115 (e.g., in cooperation with the one or more other network devices). In some examples, the communications manager 1420 may support an X2 interface within an LTE/LTE-A wireless communications network technology to provide communication between network entities 105.

The communications manager 1420 may support wireless communications in accordance with examples as disclosed herein. For example, the communications manager 1420 is capable of, configured to, or operable to support a means for outputting an SSB including a first signal, a second signal, and a PBCH, the second signal indicating first information associated with a PCID of the network entity, and the PBCH indicating second information associated with the PCID of the network entity. The communications manager 1420 is capable of, configured to, or operable to support a means for establishing a connection with a UE based on outputting the SSB.

Additionally, or alternatively, the communications manager 1420 may support wireless communications in accordance with examples as disclosed herein. For example, the communications manager 1420 is capable of, configured to, or operable to support a means for outputting an SSB including a first signal and a second signal, the second signal indicating a PCID of the network entity without additional information from the PSS. The communications manager 1420 is capable of, configured to, or operable to support a means for establishing a connection with a UE based on the PCID of the network entity.

By including or configuring the communications manager 1420 in accordance with examples as described herein, the device 1405 may support techniques for improved communication reliability, more efficient utilization of communication resources, and improved coordination between devices.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, one or more of the at least one processor 1435, one or more of the at least one memory 1425, the code 1430, or any combination thereof (for example, by a processing system including at least a portion of the at least one processor 1435, the at least one memory 1425, the code 1430, or any combination thereof). For example, the code 1430 may include instructions executable by one or more of the at least one processor 1435 to cause the device 1405 to perform various aspects of PCID indication using synchronization signals as described herein, or the at least one processor 1435 and the at least one memory 1425 may be otherwise configured to, individually or collectively, perform or support such operations.

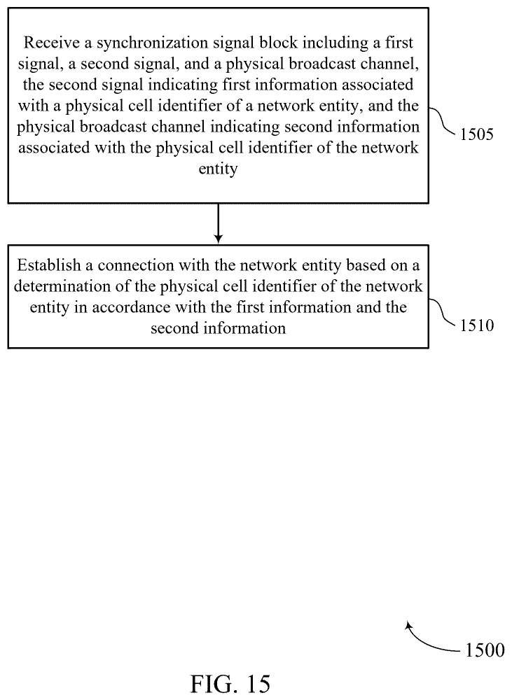

FIG. 15 shows a flowchart illustrating a method 1500 that supports PCID indication using synchronization signals in accordance with one or more aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include receiving an SSB including a first signal, a second signal, and a PBCH, the second signal indicating first information associated with a PCID of a network entity, and the PBCH indicating second information associated with the PCID of the network entity. The operations of 1505 may be performed in accordance with examples as disclosed herein. In some examples, aspects of the operations of 1505 may be performed by an SSB reception component 925 as described with reference to FIG. 9.

At 1510, the method may include establishing a connection with the network entity based on a determination of the PCID of the network entity in accordance with the first information and the second information. The operations of 1510 may be performed in accordance with examples as disclosed herein. In some examples, aspects of the operations of 1510 may be performed by a connection establishing component 930 as described with reference to FIG. 9.

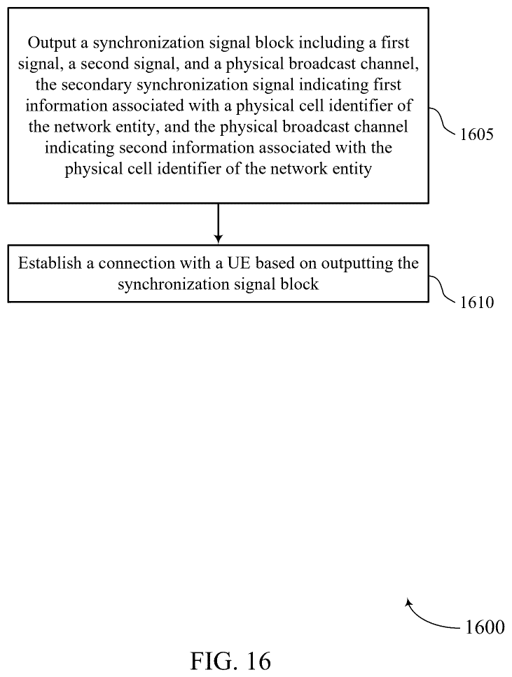

FIG. 16 shows a flowchart illustrating a method 1600 that supports PCID indication using synchronization signals in accordance with one or more aspects of the present disclosure. The operations of the method 1600 may be implemented by a network entity or its components as described herein. For example, the operations of the method 1600 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1605, the method may include outputting an SSB including a first signal, a second signal, and a PBCH, the second signal indicating first information associated with a PCID of the network entity, and the PBCH indicating second information associated with the PCID of the network entity. The operations of 1605 may be performed in accordance with examples as disclosed herein. In some examples, aspects of the operations of 1605 may be performed by an SSB outputting component 1325 as described with reference to FIG. 13.

At 1610, the method may include establishing a connection with a UE based on outputting the SSB. The operations of 1610 may be performed in accordance with examples as disclosed herein. In some examples, aspects of the operations of 1610 may be performed by a connection establishing component 1330 as described with reference to FIG. 13.

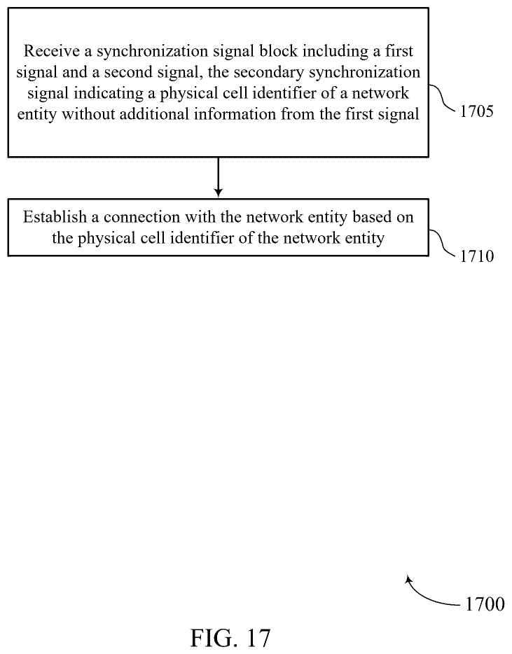

FIG. 17 shows a flowchart illustrating a method 1700 that supports PCID indication using synchronization signals in accordance with one or more aspects of the present disclosure. The operations of the method 1700 may be implemented by a UE or its components as described herein. For example, the operations of the method 1700 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1705, the method may include receiving an SSB including a first signal and a second signal, the second signal indicating a PCID of a network entity without additional information from the first signal. The operations of 1705 may be performed in accordance with examples as disclosed herein. In some examples, aspects of the operations of 1705 may be performed by an SSB reception component 925 as described with reference to FIG. 9.

At 1710, the method may include establishing a connection with the network entity based on the PCID of the network entity. The operations of 1710 may be performed in accordance with examples as disclosed herein. In some examples, aspects of the operations of 1710 may be performed by a connection establishing component 930 as described with reference to FIG. 9.

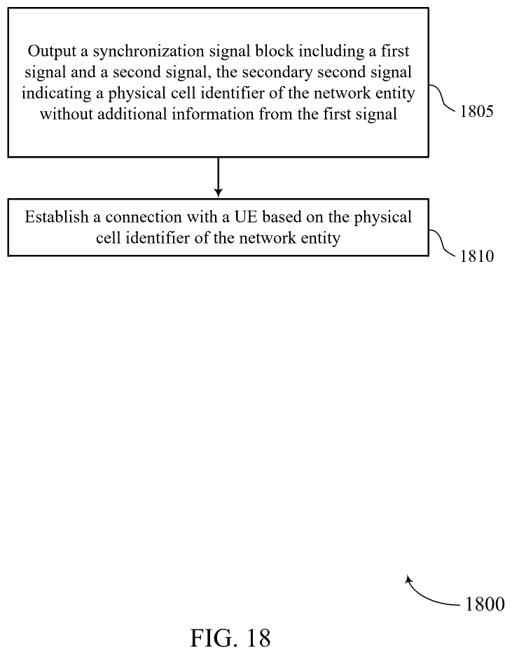

FIG. 18 shows a flowchart illustrating a method 1800 that supports PCID indication using synchronization signals in accordance with one or more aspects of the present disclosure. The operations of the method 1800 may be implemented by a network entity or its components as described herein. For example, the operations of the method 1800 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1805, the method may include outputting an SSB including a first signal and a second signal, the second signal indicating a PCID of the network entity without additional information from the first signal. The operations of 1805 may be performed in accordance with examples as disclosed herein. In some examples, aspects of the operations of 1805 may be performed by an SSB outputting component 1325 as described with reference to FIG. 13.

At 1810, the method may include establishing a connection with a UE based on the PCID of the network entity. The operations of 1810 may be performed in accordance with examples as disclosed herein. In some examples, aspects of the operations of 1810 may be performed by a connection establishing component 1330 as described with reference to FIG. 13.

The following provides an overview of aspects of the present disclosure:
Aspect 1: A method for wireless communications at a UE, comprising: receiving a synchronization signal block comprising a first signal, a second signal, and a physical broadcast channel, the second signal indicating first information associated with a physical cell identifier of a network entity, and the physical broadcast channel indicating second information associated with the physical cell identifier of the network entity; and establishing a connection with the network entity based at least in part on a determination of the physical cell identifier of the network entity in accordance with the first information and the second information.
Aspect 2: The method of aspect 1, wherein receiving the synchronization signal block comprises: receiving one or more demodulation reference signals of the physical broadcast channel indicating the second information associated with the physical cell identifier.
Aspect 3: The method of aspect 2, further comprising: descrambling the one or more demodulation reference signals of the physical broadcast channel based at least in part on the first information associated with the physical cell identifier, the determination of the physical cell identifier being based at least in part on descrambling the one or more demodulation reference signals.
Aspect 4: The method of any of aspects 1 through 3, wherein receiving the synchronization signal block comprises: receiving a master information block via the physical broadcast channel, the master information block indicating the second information associated with the physical cell identifier.
Aspect 5: The method of any of aspects 1 through 4, wherein the physical cell identifier of the network entity comprises an area identifier and a cell identifier.
Aspect 6: The method of aspect 5, wherein the first information indicated by the second signal comprises the area identifier and the second information indicated by the physical broadcast channel comprises the cell identifier.
Aspect 7: The method of any of aspects 1 through 6, further comprising: receiving control information indicating a transmission configuration indicator state, the control information comprising the physical cell identifier associated with the network entity and a source reference signal associated with the transmission configuration indicator state.
Aspect 8: A method for wireless communications at a network entity, comprising: outputting a synchronization signal block comprising a first signal, a second signal, and a physical broadcast channel, the second signal indicating first information associated with a physical cell identifier of the network entity, and the physical broadcast channel indicating second information associated with the physical cell identifier of the network entity; and establishing a connection with a UE based at least in part on outputting the synchronization signal block.
Aspect 9: The method of aspect 8, wherein outputting the synchronization signal block comprises: outputting one or more demodulation reference signals of the physical broadcast channel indicating the second information associated with the physical cell identifier.
Aspect 10: The method of aspect 9, further comprising: scrambling the one or more demodulation reference signals of the physical broadcast channel based at least in part on the first information associated with the physical cell identifier.
Aspect 11: The method of any of aspects 8 through 10, wherein outputting the synchronization signal block comprises: outputting a master information block via the physical broadcast channel, the master information block indicating the second information associated with the physical cell identifier.
Aspect 12: The method of any of aspects 8 through 11, wherein the physical cell identifier of the network entity comprises an area identifier and a cell identifier.
Aspect 13: The method of aspect 12, wherein the first information indicated by the second signal comprises the area identifier and the second information indicated by the physical broadcast channel comprises the cell identifier.
Aspect 14: The method of any of aspects 8 through 13, further comprising: outputting control information indicating a transmission configuration indicator state, the control information comprising the physical cell identifier associated with the network entity and a source reference signal associated with the transmission configuration indicator state.
Aspect 15: A method for wireless communications at a UE, comprising: receiving a synchronization signal block comprising a first signal and a second signal, the second signal indicating a physical cell identifier of a network entity without additional information from the first signal; and establishing a connection with the network entity based at least in part on the physical cell identifier of the network entity.
Aspect 16: The method of aspect 15, wherein the second signal comprises a first sequence that is mapped to a first set of resource elements and a second sequence that is mapped to a second set of resource elements, the first sequence and the second sequence indicating the physical cell identifier of the network entity.
Aspect 17: The method of aspect 16, wherein the first set of resource elements comprises a first quantity of resource elements, and the second set of resource elements comprises a second quantity of resource elements that is different from the first quantity of resource elements.
Aspect 18: The method of any of aspects 16 through 17, wherein the first set of resource elements corresponds to a first symbol index of the synchronization signal block, and the second set of resource elements corresponds to a second symbol index of the synchronization signal block that is different from the first symbol index.
Aspect 19: The method of any of aspects 16 through 18, wherein the first set of resource elements and the second set of resource elements correspond to a same symbol index of the synchronization signal block.
Aspect 20: The method of any of aspects 16 through 19, wherein a first cyclic shift applied to the first sequence and a second cyclic shift applied to the second sequence indicate the physical cell identifier of the network entity.
Aspect 21: The method of any of aspects 15 through 20, wherein receiving the synchronization signal block comprises: receiving a plurality of demodulation reference signals of a physical broadcast channel comprising the second signal, a mapping of the plurality of demodulation reference signals to resource elements of the synchronization signal block indicating the physical cell identifier of the network entity.
Aspect 22: The method of aspect 21, wherein a first symbol index of the synchronization signal block is associated with a first demodulation reference signal density, and a second symbol index of the synchronization signal block is associated with a second demodulation reference signal density.
Aspect 23: A method for wireless communications at a network entity, comprising: outputting a synchronization signal block comprising a first signal and a second signal, the second signal indicating a physical cell identifier of the network entity without additional information from the first signal; and establishing a connection with a UE based at least in part on the physical cell identifier of the network entity.
Aspect 24: The method of aspect 23, wherein the second signal comprises a first sequence that is mapped to a first set of resource elements and a second sequence that is mapped to a second set of resource elements, the first sequence and the second sequence indicating the physical cell identifier of the network entity.
Aspect 25: The method of aspect 24, wherein the first set of resource elements comprises a first quantity of resource elements, and the second set of resource elements comprises a second quantity of resource elements that is different from the first quantity of resource elements.
Aspect 26: The method of any of aspects 24 through 25, wherein the first set of resource elements corresponds to a first symbol index of the synchronization signal block, and the second set of resource elements corresponds to a second symbol index of the synchronization signal block that is different from the first symbol index.
Aspect 27: The method of any of aspects 24 through 26, wherein the first set of resource elements and the second set of resource elements correspond to a same symbol index of the synchronization signal block.
Aspect 28: The method of any of aspects 24 through 27, wherein a first cyclic shift applied to the first sequence and a second cyclic shift applied to the second sequence indicate the physical cell identifier of the network entity.
Aspect 29: The method of any of aspects 23 through 28, wherein outputting the synchronization signal block comprises: outputting a plurality of demodulation reference signals of a physical broadcast channel comprising the second signal, a mapping of the plurality of demodulation reference signals to resource elements of the synchronization signal block indicating the physical cell identifier of the network entity.
Aspect 30: The method of aspect 29, wherein a first symbol index of the synchronization signal block is associated with a first demodulation reference signal density, and a second symbol index of the synchronization signal block is associated with a second demodulation reference signal density.
Aspect 31: A UE for wireless communications, comprising one or more memories storing processor-executable code, and one or more processors coupled with the one or more memories and individually or collectively operable to execute the code to cause the UE to perform a method of any of aspects 1 through 7.
Aspect 32: A UE for wireless communications, comprising at least one means for performing a method of any of aspects 1 through 7.
Aspect 33: A non-transitory computer-readable medium storing code for wireless communications, the code comprising instructions executable by one or more processors to perform a method of any of aspects 1 through 7.
Aspect 34: A network entity for wireless communications, comprising one or more memories storing processor-executable code, and one or more processors coupled with the one or more memories and individually or collectively operable to execute the code to cause the network entity to perform a method of any of aspects 8 through 14.
Aspect 35: A network entity for wireless communications, comprising at least one means for performing a method of any of aspects 8 through 14.
Aspect 36: A non-transitory computer-readable medium storing code for wireless communications, the code comprising instructions executable by one or more processors to perform a method of any of aspects 8 through 14.
Aspect 37: A UE for wireless communications, comprising one or more memories storing processor-executable code, and one or more processors coupled with the one or more memories and individually or collectively operable to execute the code to cause the UE to perform a method of any of aspects 15 through 22.
Aspect 38: A UE for wireless communications, comprising at least one means for performing a method of any of aspects 15 through 22.
Aspect 39: A non-transitory computer-readable medium storing code for wireless communications, the code comprising instructions executable by one or more processors to perform a method of any of aspects 15 through 22.
Aspect 40: A network entity for wireless communications, comprising one or more memories storing processor-executable code, and one or more processors coupled with the one or more memories and individually or collectively operable to execute the code to cause the network entity to perform a method of any of aspects 23 through 30.
Aspect 41: A network entity for wireless communications, comprising at least one means for performing a method of any of aspects 23 through 30.
Aspect 42: A non-transitory computer-readable medium storing code for wireless communications, the code comprising instructions executable by one or more processors to perform a method of any of aspects 23 through 30.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive a synchronization signal block comprising a first signal, a second signal, and a physical broadcast channel, the second signal indicating first information associated with a physical cell identifier of a network entity, and the physical broadcast channel indicating second information associated with the physical cell identifier of the network entity; and
establish a connection with the network entity based at least in part on a determination of the physical cell identifier of the network entity in accordance with the first information and the second information.

2. The UE of claim 1, wherein, to receive the synchronization signal block, the one or more processors are individually or collectively operable to execute the code to cause the UE to:
receive one or more demodulation reference signals of the physical broadcast channel indicating the second information associated with the physical cell identifier.

3. The UE of claim 2, wherein the one or more processors are individually or collectively further operable to execute the code to cause the UE to:
descramble the one or more demodulation reference signals of the physical broadcast channel based at least in part on the first information associated with the physical cell identifier, the determination of the physical cell identifier being based at least in part on descrambling the one or more demodulation reference signals.

4. The UE of claim 1, wherein, to receive the synchronization signal block, the one or more processors are individually or collectively operable to execute the code to cause the UE to:
receive a master information block via the physical broadcast channel, the master information block indicating the second information associated with the physical cell identifier.

5. The UE of claim 1, wherein the physical cell identifier of the network entity comprises an area identifier and a cell identifier.

6. The UE of claim 5, wherein the first information indicated by the second signal comprises the area identifier and the second information indicated by the physical broadcast channel comprises the cell identifier.

7. The UE of claim 1, wherein the one or more processors are individually or collectively further operable to execute the code to cause the UE to:
receive control information indicating a transmission configuration indicator state, the control information comprising the physical cell identifier associated with the network entity and a source reference signal associated with the transmission configuration indicator state.

8. A network entity, comprising:
one or more memories storing processor-executable code; and
one or more processors coupled with the one or more memories and individually or collectively operable to execute the code to cause the network entity to:
output a synchronization signal block comprising a first signal, a second signal, and a physical broadcast channel, the second signal indicating first information associated with a physical cell identifier of the network entity, and the physical broadcast channel indicating second information associated with the physical cell identifier of the network entity; and
establish a connection with a user equipment (UE) based at least in part on outputting the synchronization signal block.

9. The network entity of claim 8, wherein, to output the synchronization signal block, the one or more processors are individually or collectively operable to execute the code to cause the network entity to:
output one or more demodulation reference signals of the physical broadcast channel indicating the second information associated with the physical cell identifier.

10. The network entity of claim 9, wherein the one or more processors are individually or collectively further operable to execute the code to cause the network entity to:
scramble the one or more demodulation reference signals of the physical broadcast channel based at least in part on the first information associated with the physical cell identifier.

11. The network entity of claim 8, wherein, to output the synchronization signal block, the one or more processors are individually or collectively operable to execute the code to cause the network entity to:
output a master information block via the physical broadcast channel, the master information block indicating the second information associated with the physical cell identifier.

12. The network entity of claim 8, wherein the physical cell identifier of the network entity comprises an area identifier and a cell identifier.

13. The network entity of claim 12, wherein the first information indicated by the second signal comprises the area identifier and the second information indicated by the physical broadcast channel comprises the cell identifier.

14. The network entity of claim 8, wherein the one or more processors are individually or collectively further operable to execute the code to cause the network entity to:
output control information indicating a transmission configuration indicator state, the control information comprising the physical cell identifier associated with the network entity and a source reference signal associated with the transmission configuration indicator state.

15. A user equipment (UE), comprising:
one or more memories storing processor-executable code; and
one or more processors coupled with the one or more memories and individually or collectively operable to execute the code to cause the UE to:
receive a synchronization signal block comprising a first signal and a second signal, the second signal indicating a physical cell identifier of a network entity without additional information from the first signal; and
establish a connection with the network entity based at least in part on the physical cell identifier of the network entity.

16. The UE of claim 15, wherein the second signal comprises a first sequence that is mapped to a first set of resource elements and a second sequence that is mapped to a second set of resource elements, the first sequence and the second sequence indicating the physical cell identifier of the network entity.

17. The UE of claim 16, wherein the first set of resource elements comprises a first quantity of resource elements, and the second set of resource elements comprises a second quantity of resource elements that is different from the first quantity of resource elements.

18. The UE of claim 16, wherein the first set of resource elements corresponds to a first symbol index of the synchronization signal block, and the second set of resource elements corresponds to a second symbol index of the synchronization signal block that is different from the first symbol index.

19. The UE of claim 16, wherein the first set of resource elements and the second set of resource elements correspond to a same symbol index of the synchronization signal block.

20. The UE of claim 16, wherein a first cyclic shift applied to the first sequence and a second cyclic shift applied to the second sequence indicate the physical cell identifier of the network entity.

21. The UE of claim 15, wherein, to receive the synchronization signal block, the one or more processors are individually or collectively operable to execute the code to cause the UE to:
receive a plurality of demodulation reference signals of a physical broadcast channel comprising the second signal, a mapping of the plurality of demodulation reference signals to resource elements of the synchronization signal block indicating the physical cell identifier of the network entity.

22. The UE of claim 21, wherein a first symbol index of the synchronization signal block is associated with a first demodulation reference signal density, and a second symbol index of the synchronization signal block is associated with a second demodulation reference signal density.

23. A network entity, comprising:
one or more memories storing processor-executable code; and
one or more processors coupled with the one or more memories and individually or collectively operable to execute the code to cause the network entity to:
output a synchronization signal block comprising a first signal and a second signal, the second signal indicating a physical cell identifier of the network entity without additional information from the first signal; and
establish a connection with a user equipment (UE) based at least in part on the physical cell identifier of the network entity.

24. The network entity of claim 23, wherein the second signal comprises a first sequence that is mapped to a first set of resource elements and a second sequence that is mapped to a second set of resource elements, the first sequence and the second sequence indicating the physical cell identifier of the network entity.

25. The network entity of claim 24, wherein the first set of resource elements comprises a first quantity of resource elements, and the second set of resource elements comprises a second quantity of resource elements that is different from the first quantity of resource elements.

26. The network entity of claim 24, wherein the first set of resource elements corresponds to a first symbol index of the synchronization signal block, and the second set of resource elements corresponds to a second symbol index of the synchronization signal block that is different from the first symbol index.

27. The network entity of claim 24, wherein the first set of resource elements and the second set of resource elements correspond to a same symbol index of the synchronization signal block.

28. The network entity of claim 24, wherein a first cyclic shift applied to the first sequence and a second cyclic shift applied to the second sequence indicate the physical cell identifier of the network entity.

29. The network entity of claim 23, wherein, to output the synchronization signal block, the one or more processors are individually or collectively operable to execute the code to cause the network entity to:
output a plurality of demodulation reference signals of a physical broadcast channel comprising the second signal, a mapping of the plurality of demodulation reference signals to resource elements of the synchronization signal block indicating the physical cell identifier of the network entity.

30. The network entity of claim 29, wherein a first symbol index of the synchronization signal block is associated with a first demodulation reference signal density, and a second symbol index of the synchronization signal block is associated with a second demodulation reference signal density.
